(19) United States
(12) Patent Application Publication
(10) Pub. No.: US 2024/0049237 A1
(43) Pub. Date: Feb. 8, 2024

(54) METHOD AND DEVICE IN NODES USED FOR WIRELESS COMMUNICATION

(71) Applicants: Zheng LIU, Shanghai (CN); Zhongzhi YANG, Shanghai (CN)

(72) Inventors: Zheng LIU, Shanghai (CN); Zhongzhi YANG, Shanghai (CN)

(73) Assignee: SHANGHAI LANGBO COMMUNICATION TECHNOLOGY COMPANY LIMITED, Shanghai (CN)

(21) Appl. No.: 18/379,671

(22) Filed: Oct. 13, 2023

Related U.S. Application Data
(63) Continuation of application No. PCT/CN2021/125387, filed on Oct. 21, 2021.

(30) Foreign Application Priority Data
Apr. 26, 2021 (CN) 202110463733.9

(51) Int. Cl. H04W 72/21; H04W 72/563

(52) U.S. Cl. CPC H04W 72/21; H04W 72/563

(57) ABSTRACT

Method and device for wireless communications. A node receives a first information block; the node transmits a first PUCCH; the first information block determines a first scrambling sequence; the first PUCCH carries a first bit block and a second bit block; a number of bit(s) comprised in the first bit block is not greater than 2; a sum of a number of bit(s) comprised in the first bit block and the second bit block is greater than 2; a priority index of the first bit block is equal to a first priority index, a priority index of the second bit block is equal to a second priority index, and the first priority index and the second priority index are not equal; the first bit block and the second bit block are used together to generate a first bit sequence. Present application improves the link performance of the PUCCH.

### CROSS REFERENCE TO RELATED APPLICATIONS

This application is the international patent application No. PCT/CN2021/125387, filed on Oct. 21,2021, and claims the priority benefit of Chinese Patent Application No. 202110463733.9, filed on Apr. 25,2021, the full disclosure of which is incorporated herein by reference.

### BACKGROUND

### Technical Field

The present application relates to transmission methods and devices in wireless communication systems, and in particular to a transmission scheme and device related to information with different priorities in wireless communications.

### Related Art

Application scenarios of future wireless communication systems are becoming increasingly diversified, and different application scenarios have different performance demands on systems. In order to meet different performance requirements of various application scenarios, it was decided at 3rd Generation Partner Project (3GPP) Radio Access Network (RAN) #72th plenary that a study on New Radio (NR), or what is called Fifth Generation (5G) shall be conducted. The work item of NR was approved at 3GPP RAN #75th plenary to standardize NR. A Study Item (SI) and a Work Item (WI) of NR Rel-17 was decided to start at 3GPP RAN #86 plenary.

In new radio technology, enhanced Mobile BroadBand (eMBB), Ultra-reliable and Low Latency Communications (URLLC), and massive Machine Type Communications (mMTC) are the three main application scenarios.

### SUMMARY

In URLLC communications, there exist transmissions of data or control information with different priorities. In NR Rel-16, when Uplink Control Information (UCIs) with different priorities collide with each other in time domain, a UCI with low-priority will be dropped to ensure a transmission of a UCI with a high priority. In NR Rel-17, the multiplexing of UCIs with different priorities onto a same PUCCH or a same PUSCH is supported.

The present application discloses a solution to the multiplexing problem of UCIs associated with different priorities. It should be noted that though the present application only took URLLC for example in the statement above; the present application is also applicable to other scenarios facing similar problems (such as scenarios where multiple services coexist, or other scenarios of the multiplexing of information with different priorities, or scenarios of the multiplexing of services with different QoS requirements, or for different application scenarios, such as Internet of Vehicles and eMBB multiplexing, etc.), where similar technical effects can be achieved. Additionally, the adoption of a unified solution for various scenarios, including but not limited to scenarios and URLLC, contributes to the reduction of hardware complexity and costs. If no conflict is incurred, embodiments in a first node in the present application and the characteristics of the embodiments are also applicable to a second node, and vice versa. Particularly, for interpretations of the terminology, nouns, functions and variants (if not specified) in the present application, refer to definitions given in TS36 series, TS38 series and TS37 series of 3GPP specifications.

The present application provides a method in a first node for wireless communications, comprising:

receiving a first information block, the first information block being used to determine a first parameter value, the first parameter value being used to generate a first scrambling sequence, the first parameter value being a non-negative integer, the first scrambling sequence comprising multiple sequentially indexed bits; and

transmitting a first PUCCH, the first PUCCH being used to carry a first bit block and a second bit block, the first bit block comprising at least one control information bit, and the second bit block comprising at least one control information bit;

herein, a number of control information bit(s) comprised in the first bit block is not greater than 2; a sum of a number of control information bit(s) comprised in the first bit block and a number of control information bit(s) comprised in the second bit block is greater than 2; a priority index of a control information bit comprised in the first bit block is equal to a first priority index, a priority index of a control information bit comprised in the second bit block is equal to a second priority index, and the first priority index is not equal to the second priority index; the first bit block and the second bit block are used together to generate a first bit sequence, and the first bit sequence comprises multiple sequentially indexed bits; the first bit sequence comprises at least one placeholder bit, a non-placeholder bit comprised in the first bit sequence is scrambled by a bit with a same index in the first scrambling sequence.

In one embodiment, placeholder bits are introduced into the scrambling process of a PUCCH, so that when UCI bits with different priorities are multiplexed on the PUCCH and coding is respectively performed on a high-priority UCI and a low-priority UCI, thus ensuring the link transmission performance of the PUCCH transmitting one to two bit high-priority UCI or low-priority UCI.

According to one aspect of the present application, the above method is characterized in that a modulation order of a modulation scheme adopted by the first PUCCH is equal to a first modulation order, and the first modulation order is a positive integer greater than 1; a number of control information bit(s) comprised in the first bit block being less than the first modulation order is used to determine that the first bit sequence comprises at least one placeholder bit.

In one embodiment, only when a modulation order is greater than a number of information bit(s), a placeholder bit is introduced, which can maximize the Euclidean distance and improve the transmission robustness.

According to one aspect of the present application, the above method is characterized in that the first bit sequence and the first scrambling sequence are used together to generate a first output sequence, the first output sequence comprises multiple sequentially indexed bits, and a number of bits comprised in the first output sequence is equal to a number of bits comprised in the first bit sequence; a first index is an index of a placeholder bit comprised in the first bit sequence, a bit with index equal to the first index comprised in the first output sequence is a first bit, a second bit is a bit comprised in the first output sequence, the second index is an index of the second bit in the first output sequence, the second index and the first index are two adjacent indexes, and a bit value of the first bit is equal to a bit value of the second bit.

In one embodiment, when scrambling placeholder bits, considering the limitations of PUCCH modulation and a number of UCI bit(s), only placeholder bits for repartitions are introduced to simplify the standardization work.

According to one aspect of the present application, the above method is characterized in comprising:

receiving a second information block;

herein, the second information block is used to determine X1 resource sets, X1 being a positive integer greater than 1; any of the X1 resource sets comprises at least one PUCCH resource, resources occupied by the first PUCCH belong to a target PUCCH resource, and the target PUCCH resource is a PUCCH resource comprised in a target resource set; the target resource set is one of the X1 resource sets, and a target number value is used to determine the target resource set out of the X1 resource sets, the target number value being a positive integer; at least one of a number of control information bit(s) comprised in the first bit block, or a number of control information bit(s) comprised in the second bit block is used to determine the target number value.

According to one aspect of the present application, the above method is characterized in comprising:

receiving a first signaling;

herein, when the target resource set comprises more than one PUCCH resource, the first signaling is used to determine the target PUCCH resource from the target resource set.

According to one aspect of the present application, the above method is characterized in that whether a number of control information bit(s) comprised in the second bit block is used to determine that the target number value is related to the second priority index.

In one embodiment, according to priority, whether a number of bits of a corresponding UCI is counted in the PUCCH resource determination process is judged, thus ensuring the robustness of the transmission of high-priority UCIs in the case of high and low priority multiplexing.

According to one aspect of the present application, the method is characterized in that the second information block is used to determine a first coding rate, the first coding rate being a non-negative number; a number of Physical Resource Block(s) occupied by the first PUCCH in frequency domain is equal to a first number value; the first coding rate is used to determine the first number value, and a number of bit(s) comprised in the first bit sequence is directly proportional to the first number value; a type of a UCI carried by the first PUCCH is used to determine the first coding rate.

In one embodiment, coding rate at the time of rate matching is dynamically selected for a type of UCI, which further ensures the robustness of the transmission of high-priority UCIs and backward compatibility at the same time.

The present application provides a method in a second node for wireless communications, comprising:

transmitting a first information block, the first information block being used to indicate a first parameter value, the first parameter value being used to generate a first scrambling sequence, the first parameter value being a non-negative integer, the first scrambling sequence comprising multiple sequentially indexed bits; and

receiving a first PUCCH, the first PUCCH being used to carry a first bit block and a second bit block, the first bit block comprising at least one control information bit, and the second bit block comprising at least one control information bit;

herein, a number of control information bit(s) comprised in the first bit block is not greater than 2; a sum of a number of control information bit(s) comprised in the first bit block and a number of control information bit(s) comprised in the second bit block is greater than 2; a priority index of a control information bit comprised in the first bit block is equal to a first priority index, a priority index of a control information bit comprised in the second bit block is equal to a second priority index, and the first priority index is not equal to the second priority index; the first bit block and the second bit block are used together to generate a first bit sequence, and the first bit sequence comprises multiple sequentially indexed bits; the first bit sequence comprises at least one placeholder bit, a non-placeholder bit comprised in the first bit sequence is scrambled by a bit with a same index in the first scrambling sequence.

According to one aspect of the present application, the above method is characterized in that a modulation order of a modulation scheme adopted by the first PUCCH is equal to a first modulation order, and the first modulation order is a positive integer greater than 1; a number of control information bit(s) comprised in the first bit block being less than the first modulation order is used to determine that the first bit sequence comprises at least one placeholder bit.

According to one aspect of the present application, the above method is characterized in that the first bit sequence and the first scrambling sequence are used together to generate a first output sequence, the first output sequence comprises multiple sequentially indexed bits, and a number of bits comprised in the first output sequence is equal to a number of bits comprised in the first bit sequence; a first index is an index of a placeholder bit comprised in the first bit sequence, a bit with index equal to the first index comprised in the first output sequence is a first bit, a second bit is a bit comprised in the first output sequence, the second index is an index of the second bit in the first output sequence, the second index and the first index are two adjacent indexes, and a bit value of the first bit is equal to a bit value of the second bit.

According to one aspect of the present application, the above method is characterized in comprising:

transmitting a second information block;

herein, the second information block is used to determine X1 resource sets, X1 being a positive integer greater than 1; any of the X1 resource sets comprises at least one PUCCH resource, resources occupied by the first PUCCH belong to a target PUCCH resource, and the target PUCCH resource is a PUCCH resource comprised in a target resource set; the target resource set is one of the X1 resource sets, and a target number value is used to determine the target resource set out of the X1 resource sets, the target number value being a positive integer; at least one of a number of control information bit(s) comprised in the first bit block, or a number of control information bit(s) comprised in the second bit block is used to determine the target number value.

According to one aspect of the present application, the above method is characterized in comprising:

transmitting a first signaling;

herein, when the target resource set comprises more than one PUCCH resource, the first signaling is used to determine the target PUCCH resource from the target resource set.

According to one aspect of the present application, the above method is characterized in that whether a number of control information bit(s) comprised in the second bit block is used to determine that the target number value is related to the second priority index.

According to one aspect of the present application, the method is characterized in that the second information block is used to determine a first coding rate, the first coding rate being a non-negative number; a number of Physical Resource Block(s) occupied by the first PUCCH in frequency domain is equal to a first number value; the first coding rate is used to determine the first number value, and a number of bit(s) comprised in the first bit sequence is directly proportional to the first number value; a type of a UCI carried by the first PUCCH is used to determine the first coding rate.

The present application provides a first node for wireless communications, comprising:

a first receiver, receiving a first information block, the first information block being used to determine a first parameter value, the first parameter value being used to generate a first scrambling sequence, the first parameter value being a non-negative integer, the first scrambling sequence comprising multiple sequentially indexed bits; and

a first transmitter, transmitting a first PUCCH, the first PUCCH being used to carry a first bit block and a second bit block, the first bit block comprising at least one control information bit, and the second bit block comprising at least one control information bit;

herein, a number of control information bit(s) comprised in the first bit block is not greater than 2; a sum of a number of control information bit(s) comprised in the first bit block and a number of control information bit(s) comprised in the second bit block is greater than 2; a priority index of a control information bit comprised in the first bit block is equal to a first priority index, a priority index of a control information bit comprised in the second bit block is equal to a second priority index, and the first priority index is not equal to the second priority index; the first bit block and the second bit block are used together to generate a first bit sequence, and the first bit sequence comprises multiple sequentially indexed bits; the first bit sequence comprises at least one placeholder bit, a non-placeholder bit comprised in the first bit sequence is scrambled by a bit with a same index in the first scrambling sequence.

The present application provides a second node for wireless communications, comprising:

a second transmitter, transmitting a first information block, the first information block being used to indicate a first parameter value, the first parameter value being used to generate a first scrambling sequence, the first parameter value being a non-negative integer, the first scrambling sequence comprising multiple sequentially indexed bits; and

a second receiver, receiving a first PUCCH, the first PUCCH being used to carry a first bit block and a second bit block, the first bit block comprising at least one control information bit, and the second bit block comprising at least one control information bit;

herein, a number of control information bit(s) comprised in the first bit block is not greater than 2; a sum of a number of control information bit(s) comprised in the first bit block and a number of control information bit(s) comprised in the second bit block is greater than 2; a priority index of a control information bit comprised in the first bit block is equal to a first priority index, a priority index of a control information bit comprised in the second bit block is equal to a second priority index, and the first priority index is not equal to the second priority index; the first bit block and the second bit block are used together to generate a first bit sequence, and the first bit sequence comprises multiple sequentially indexed bits; the first bit sequence comprises at least one placeholder bit, a non-placeholder bit comprised in the first bit sequence is scrambled by a bit with a same index in the first scrambling sequence.

In one embodiment, the method in the present application is advantageous in the following aspects:
the present application introduces placeholder bits into the scrambling process of a PUCCH, so that when UCI bits with different priorities are multiplexed on the PUCCH and coding is respectively performed on a high-priority UCI and a low-priority UCI, thus ensuring the link transmission performance of the PUCCH transmitting one to two bit high-priority UCI or low-priority UCI.
using the method in this application, only when a modulation order is greater than a number of information bit(s), a placeholder bit is introduced, which can maximize the Euclidean distance and improve the transmission robustness;
when adopting the method in the present application to scramble placeholder bits, considering the limitations of PUCCH modulation and a number of UCI bit(s), only placeholder bits for reprtitions are introduced to simplify the standardization work.
method in the present application, according to priority, judges whether a number of bits of a corresponding UCI is counted in the PUCCH resource determination process, thus ensuring the robustness of the transmission of high-priority UCIs in the case of high and low priority multiplexing.
method in the present application supports dynamically selecting coding rate at the time of rate matching for a type of UCI, which further ensures the robustness of the transmission of high-priority UCIs and backward compatibility at the same time.

### BRIEF DESCRIPTION OF THE DRAWINGS

Other features, objects and advantages of the present application will become more apparent from the detailed description of non-restrictive embodiments taken in conjunction with the following drawings:

FIG. 1 illustrates a flowchart of a first information block and a first PUCCH according to one embodiment of the present application;

FIG. 2 illustrates a schematic diagram of a network architecture according to one embodiment of the present application;

FIG. 3 illustrates a schematic diagram of a radio protocol architecture of a user plane and a control plane according to one embodiment of the present application;

FIG. 4 illustrates a schematic diagram of a first node and a second node according to one embodiment of the present application;

FIG. 5 illustrates a flowchart of radio signal transmission according to one embodiment of the present application;

FIG. 6 illustrate a schematic diagram of a relation between a first modulation order and a first bit block according to one embodiment of the present application;

FIG. 7 illustrates a schematic diagram of a relation between a first bit and a second bit according to one embodiment of the present application;

FIG. 8 illustrates a schematic diagram of a relation between a target number value and a target resource set according to one embodiment of the present application;

FIG. 9 illustrates a schematic diagram of a relation between a target number value and a second priority index according to one embodiment of the present application;

FIG. 10 illustrates a schematic diagram of a first number value according to one embodiment of the present application;

FIG. 11 illustrates a structure block diagram of a processor in a first node according to one embodiment of the present application;

FIG. 12 illustrates a structure block diagram of a processor in second node according to one embodiment of the present application.

### DESCRIPTION OF THE EMBODIMENTS

The technical scheme of the present application is described below in further details in conjunction with the drawings. It should be noted that the embodiments of the present application and the characteristics of the embodiments may be arbitrarily combined if no conflict is caused.

### Embodiment 1

Embodiment 1 illustrates a flowchart of a first information block and a first PUCCH according to one embodiment of the present application, as shown in FIG. 1. In FIG. 1, each box represents a step. Particularly, the sequential order of steps in these boxes does not necessarily mean that the steps are chronologically arranged.

In Embodiment 1, a first node in the present application receives a first information block in step 101; a first node in the present application transmits a first PUCCH in step 102; the first information block is used to determine a first parameter value, the first parameter value is used to generate a first scrambling sequence, the first parameter value is a non-negative integer, the first scrambling sequence comprises multiple sequentially indexed bits; the first PUCCH is used to carry a first bit block and a second bit block, the first bit block comprises at least one control information bit, and the second bit block comprises at least one control information bit; a number of control information bit(s) comprised in the first bit block is not greater than 2; a sum of a number of control information bit(s) comprised in the first bit block and a number of control information bit(s) comprised in the second bit block is greater than 2; a priority index of a control information bit comprised in the first bit block is equal to a first priority index, a priority index of a control information bit comprised in the second bit block is equal to a second priority index, and the first priority index is not equal to the second priority index; the first bit block and the second bit block are used together to generate a first bit sequence, and the first bit sequence comprises multiple sequentially indexed bits; the first bit sequence comprises at least one placeholder bit, a non-placeholder bit comprised in the first bit sequence is scrambled by a bit with a same index in the first scrambling sequence.

In one embodiment, the first information block is transmitted via an air interface or a radio interface.

In one embodiment, the first information block comprises all or part of a higher-layer or physical-layer signaling.

In one embodiment, the first information block comprises all or part of a Radio Resource Control (RRC)-layer signaling or a Medium Access Control (MAC) layer signaling.

In one embodiment, the first information block is carried through a Physical Downlink Shared Channel (PDSCH).

In one embodiment, the first information block is carried through a Synchronization/Physical Broadcast Channel (SS/PBCH) block.

In one embodiment, the first information block is carried through a Primary Synchronization Signal (PSS) and a Secondary Synchronization Signal (SSS).

In one embodiment, the first information block is cell-specific or UE-specific.

In one embodiment, the first information block is Per Bandwidth Part (BWP) Configured.

In one embodiment, the first information block comprises all or partial fields in a Downlink Control Information (DCI) format.

In one embodiment, the first information block comprises more than one sub-information block, and each sub-information block comprised in the first information block is an Information Element (IE) or a field in an RRC signaling to which the first information block belongs; one or multiple sub-information blocks comprised in the first information block is used to determine the first parameter.

In one embodiment, the first information block comprises all or partial fields in an IE “dataScramblingIdentityPUSCH” in an RRC signaling.

In one embodiment, the first information block comprises all or partial fields in an IE “PUSCH-Config” in an RRC signaling.

In one embodiment, the first information block comprises all or partial fields in an IE “PUCCH-Config” in an RRC signaling.

In one embodiment, the first information block comprises all or partial fields in an IE “BWP-UplinkDedicated” in an RRC signaling.

In one embodiment, the expression of “the first information block being used to determine a first parameter value” in the claim comprises the following meaning: the first information block is used by the first node in the present application to determine the first parameter value.

In one embodiment, the expression of “the first information block being used to determine a first parameter value” in the claim comprises the following meaning: the first information block is used to explicitly indicate the first parameter value.

In one embodiment, the expression of “the first information block being used to determine a first parameter value” in the claim comprises the following meaning: the first information block is used to implicitly indicate the first parameter value.

In one embodiment, the first parameter value is equal to a Physical Cell ID (PCID) of a serving cell to which the first information block belongs.

In one embodiment, the first parameter value is equal to one of 0, 1, 2 . . . , 1023.

In one embodiment, the first parameter value is greater than 1023.

In one embodiment, the first scrambling sequence is a pseudo-random sequence.

In one embodiment, the first scrambling sequence is a Gold sequence with a length equal to 31.

In one embodiment, the first scrambling sequence is an m sequence.

In one embodiment, the expression of “the first parameter value being used to generate a first scrambling sequence” in the claim comprises the following meaning: the first parameter value is used to calculate an initial value of a generator of the first scrambling sequence.

In one embodiment, the expression of “the first parameter value being used to generate a first scrambling sequence” in the claim comprises the following meaning: the first parameter value is used to initialize a generator of the first scrambling sequence.

In one embodiment, the expression of “the first parameter value being used to generate a first scrambling sequence” in the claim comprises the following meaning: the first parameter value is used to initialize a register of a generator of the first scrambling sequence.

In one embodiment, the expression of “the first parameter value being used to generate a first scrambling sequence” in the claim comprises the following meaning: the first parameter value is used to calculate a first initial value, and the first initial value is used to initialize a generator of the first scrambling sequence. In one subsidiary embodiment of the above embodiment, a C-RNTI configured to the first node is used to calculate the first initial value.

In one embodiment, a number of bit(s) comprised in the first scrambling sequence is equal to a number of bit(s) comprised in the first bit sequence.

In one embodiment, a number of bit(s) comprised in the first scrambling sequence is not equal to a number of bit(s) comprised in the first bit sequence.

In one embodiment, bits comprised in the first scrambling sequence are indexed in order of 0, 1, 2 . . . .

In one embodiment, the first PUCCH comprises a radio frequency signal of a Physical Uplink Control Channel (PUCCH).

In one embodiment, the first PUCCH comprises a baseband signal of a PUCCH.

In one embodiment, the first PUCCH carries Uplink Control Information (UCI).

In one embodiment, a UCI payload adopting a UCI format is used to generate the first PUCCH.

In one embodiment, the first PUCCH adopts PUCCH format 2.

In one embodiment, the first PUCCH adopts PUCCH format 3 or 4.

In one embodiment, the first PUCCH only occupies a PRB in frequency domain.

In one embodiment, the first PUCCH occupies more than one PRB in frequency domain.

In one embodiment, the first bit block comprises information bits and CRC bits.

In one embodiment, the first bit block only comprises an information bit.

In one embodiment, the second bit block comprises an information bit and a CRC bit.

In one embodiment, the second bit block only comprises an information bit.

In one embodiment, the first bit block only comprises one HARQ-ACK bit.

In one embodiment, the first bit block comprises more than one HARQ-ACK bit.

In one embodiment, the first bit block comprises an bit other than a HARQ-ACK bit.

In one embodiment, the first bit block is a UCI payload.

In one embodiment, the second bit block only comprises one HARQ-ACK bit.

In one embodiment, the second bit block comprises more than one HARQ-ACK bit.

In one embodiment, the second bit block comprises a bit other than a HARQ-ACK bit.

In one embodiment, the second bit block is a UCI payload.

In one embodiment, the first bit block only comprises a HARQ-ACK bit.

In one embodiment, the second bit block only comprises a HARQ-ACK bit.

In one embodiment, the first bit block comprises a Channel Status Information (CSI) bit.

In one embodiment, the first bit block does not comprise a CSI bit.

In one embodiment, the second bit block comprises a Channel Status Information (CSI) bit.

In one embodiment, the second bit block does not comprise a CSI bit.

In one embodiment, the expression of “the first PUCCH being used to carry a first bit block and a second bit block” in the claim comprises the following: the first PUCCH is used by the first node in the present application to carry the first bit block and the second bit block.

In one embodiment, the expression of “the first PUCCH being used to carry a first bit block and a second bit block” in the claim comprises the following: the first bit block and the second bit block are used to generate the first PUCCH.

In one embodiment, the expression of “the first PUCCH being used to carry a first bit block and a second bit block” in the claim comprises the following: the first bit block and the second bit block are transmitted on the first PUCCH.

In one embodiment, the expression of “the first PUCCH being used to carry a first bit block and a second bit block” in the claim comprises the following: the first bit block and the second bit block are used to generate a codeword of the first PUCCH.

In one embodiment, the expression of “the first PUCCH being used to carry a first bit block and a second bit block” in the claim comprises the following: a bit block acquired after the first bit block is through channel coding and a bit block acquired after the second bit block is through channel coding are used together to generate the first PUCCH.

In one embodiment, a number of control information bit(s) comprised in the second bit block is not greater than 2.

In one embodiment, a number of control information bit(s) comprised in the second bit block is greater than 2.

In one embodiment, a number of control information bit(s) comprised in the second bit block is equal to 1.

In one embodiment, a number of control information bit(s) comprised in the second bit block is equal to 2.

In one embodiment, a number of control information bit(s) comprised in the first bit block is equal to 1.

In one embodiment, a number of control information bit(s) comprised in the first bit block is equal to 2.

In one embodiment, the first priority index is a non-negative integer.

In one embodiment, the first priority index is equal to one of 0 or 1.

In one embodiment, the first priority index is a positive integer.

In one embodiment, the second priority index is a non-negative integer.

In one embodiment, the second priority index is equal to one of 0 or 1.

In one embodiment, the second priority index is a positive integer.

In one embodiment, the first priority index is greater than the second priority index.

In one embodiment, the first priority index is less than the second priority index.

In one embodiment, a priority index of a control information bit comprised in the first bit block is a priority index of a PDSCH associated with a control information bit comprised in the first bit block.

In one embodiment, a priority index of a control information bit comprised in the first bit block is a priority index indicated by a DCI format carried by a PDCCH associated with a control information bit comprised in the first bit block.

In one embodiment, a priority index of a control information bit comprised in the first bit block is a value of a priority indicator carried by a PDCCH associated with a control information bit comprised in the first bit block.

In one embodiment, a priority index of a control information bit comprised in the second bit block is a priority index of a PDSCH associated with a control information bit comprised in the second bit block.

In one embodiment, a priority index of a control information bit comprised in the second bit block is a priority index indicated by a DCI format carried by a PDCCH associated with a control information bit comprised in the second bit block.

In one embodiment, a priority index of a control information bit comprised in the second bit block is a value of a priority indicator carried by a PDCCH associated with a control information bit comprised in the second bit block.

In one embodiment, the first PUCCH corresponds to the first priority index.

In one embodiment, a priority index associated with the first PUCCH is equal to the first priority index.

In one embodiment, a priority index indicated by a DCI format indicating time-frequency resources occupied by the first PUCCH is equal to the first priority index.

In one embodiment, a value of a priority indicator carried by a DCI format indicating time-frequency resources occupied by the first PUCCH is equal to the first priority index.

In one embodiment, a priority index indicated by a DCI format carrying a PUCCH Resource Indicator (PRI) for the first PUCCH is equal to the first priority index.

In one embodiment, a value of a priority indicator carried by a DCI format carrying a PRI for the first PUCCH is equal to the first priority index.

In one embodiment, the first PUCCH corresponds to the second priority index.

In one embodiment, a priority index associated with the first PUCCH is equal to the second priority index.

In one embodiment, a priority index indicated by a DCI format indicating time-frequency resources occupied by the first PUCCH is equal to the second priority index.

In one embodiment, a value of a priority indicator carried by a DCI format indicating time-frequency resources occupied by the first PUCCH is equal to the second priority index.

In one embodiment, a priority index indicated by a DCI format carrying a PUCCH Resource Indicator (PRI) for the second PUCCH is equal to the first priority index.

In one embodiment, a value of a priority indicator carried by a DCI format carrying a PRI for the second PUCCH is equal to the first priority index.

In one embodiment, the first PUCCH corresponds to a greater priority index compared between the first priority index and the second priority index.

In one embodiment, a priority index associated with the first PUCCH is equal to a greater priority index compared between the first priority index and the second priority index.

In one embodiment, the first PUCCH corresponds to a smaller priority index compared between the first priority index and the second priority index.

In one embodiment, a priority index associated with the first PUCCH is equal to a smaller priority index compared between the first priority index and the second priority index.

In one embodiment, a priority index indicated by a DCI format indicating time-frequency resources occupied by the first PUCCH is equal to a greater priority index compared between the first priority index and the second priority index.

In one embodiment, a value of a priority indicator carried by a DCI format indicating time-frequency resources occupied by the first PUCCH is equal to a greater priority index compared between the first priority index and the second priority index.

In one embodiment, a priority index indicated by a DCI format carrying a PUCCH Resource Indicator (PRI) for the first PUCCH is equal to a greater priority index compared between the first priority index and the second priority index.

In one embodiment, a value of apriority indicator carried by a DCI format of a PRI for the first PUCCH is equal to a greater priority index compared between the first priority index and the second priority index.

In one embodiment, a priority index indicated by a DCI format indicating time-frequency resources occupied by the first PUCCH is equal to a smaller priority index compared between the first priority index and the second priority index.

In one embodiment, a value of a priority indicator carried by a DCI format indicating time-frequency resources occupied by the first PUCCH is equal to a smaller priority index compared between the first priority index and the second priority index.

In one embodiment, a priority index indicated by a DCI format carrying a PUCCH Resource Indicator (PRI) for the first PUCCH is equal to a smaller priority index compared between the first priority index and the second priority index.

In one embodiment, a value of apriority indicator carried by a DCI format of a PRI for the first PUCCH is equal to a smaller priority index compared between the first priority index and the second priority index.

In one embodiment, the expression of “the first bit block and the second bit block being used together to generate a first bit sequence” in the claim comprises the following meaning: the first bit block and the second bit block are used together by the first node in the present application to generate the first bit sequence.

In one embodiment, the expression of “the first bit block and the second bit block being used together to generate a first bit sequence” in the claim comprises the following meaning: a bit block acquired after the first bit block through channel coding and a bit block acquired after the second bit block through channel coding are used together to generate the first bit sequence.

In one embodiment, the expression of “the first bit block and the second bit block being used together to generate a first bit sequence” in the claim comprises the following meaning: a bit block acquired after the first bit block through channel coding then through rate matching is concatenated with a bit block acquired after the second bit block through channel coding then through rate matching to generate the first bit sequence.

In one embodiment, the expression of “the first bit block and the second bit block being used together to generate a first bit sequence” in the claim comprises the following meaning: the first bit block generates a first target bit sequence sequentially through channel coding and rate matching, the second bit block generates a second target bit sequence sequentially through channel coding and rate matching, and the first bit sequence is acquired after concatenating the first target bit sequence with the second target bit sequence.

In one embodiment, the expression of “the first bit block and the second bit block being used together to generate a first bit sequence” in the claim comprises the following meaning: the first bit block generates a first target bit sequence sequentially through channel coding and rate matching, the second bit block generates a second target bit sequence sequentially through CRC insertion, channel coding and rate matching, and the first bit sequence is acquired after concatenating the first target bit sequence with the second target bit sequence.

In one embodiment, the expression of “the first bit block and the second bit block being used together to generate a first bit sequence” in the claim comprises the following meaning: the first bit block generates a first target bit sequence sequentially through channel coding and rate matching, the second bit block is used to generate a third bit block, a number of bit(s) comprised in the third bit block is less than the second bit block, the third bit block generates a second target bit sequence sequentially through CRC insertion, channel coding and rate matching, and the first bit sequence is acquired after concatenating the first target bit sequence with the second target bit sequence.

In one embodiment, the expression of “the first bit block and the second bit block being used together to generate a first bit sequence” in the claim comprises the following meaning: the first bit block generates a first target bit sequence sequentially through channel coding and rate matching, the second bit block is used to generate a third bit block, a number of bit(s) comprised in the third bit block is less than the second bit block, the third bit block generates a second target bit sequence sequentially through channel coding and rate matching, and the first bit sequence is acquired after concatenating the first target bit sequence with the second target bit sequence.

In one embodiment, the expression of “the first bit block and the second bit block being used together to generate a first bit sequence” in the claim comprises the following meaning: the first bit block generates a first target bit sequence sequentially through channel coding and rate matching, the second bit block is used to generate a third bit block through compression or dropping or bundling, a number of bit(s) comprised in the third bit block is less than the second bit block, the third bit block generates a second target bit sequence sequentially through channel coding and rate matching, and the first bit sequence is acquired after concatenating the first target bit sequence with the second target bit sequence.

In one embodiment, the first bit sequence is indexed in order of 0, 1, 2, . . . .

In one embodiment, the Placeholder bit is a Placeholder bit in repeated coding.

In one embodiment, the Placeholder bit is a Placeholder bit in Simplex coding.

In one embodiment, the Placeholder bit is a bit marked as “x” in repeat coding or Simplex coding.

In one embodiment, the Placeholder bit is a bit marked as “y” in repeat coding or Simplex coding.

In one embodiment, the Placeholder bit is a bit marked as “x” or “y” in repeat coding or Simplex coding.

In one embodiment, the Placeholder bit is a bit not being scrambled in scrambling procedure.

In one embodiment, the Placeholder bit is a bit that needs to be specially processed.

In one embodiment, the Placeholder bit is a bit used to maximize a Euclidean Distance.

In one embodiment, the expression in the claim of “a non-placeholder bit comprised in the first bit sequence being scrambled by a bit with a same index in the first scrambling sequence” comprises the following meaning: any non-placeholder bit comprised in the first bit sequence is scrambled by a bit with a same index in the first scrambling sequence.

In one embodiment, the expression in the claim of “a non-placeholder bit comprised in the first bit sequence being scrambled by a bit with a same index in the first scrambling sequence” comprises the following meaning: a non-placeholder bit comprised in the first bit sequence and a bit with a same index in the first scrambling sequence perform logical AND operation.

In one embodiment, the expression in the claim of “a non-placeholder bit comprised in the first bit sequence being scrambled by a bit with a same index in the first scrambling sequence” comprises the following meaning: a non-placeholder bit comprised in the first bit sequence and a bit with a same index in the first scrambling sequence perform logical OR operation.

In one embodiment, the expression in the claim of “a non-placeholder bit comprised in the first bit sequence being scrambled by a bit with a same index in the first scrambling sequence” comprises the following meaning: bits comprised in the first bit sequence respectively correspond bits comprised in the first scrambling sequence, and any non-placeholder bit comprised in the first bit sequence and a corresponding bit in the first scrambling sequence perform logical AND operation.

In one embodiment, the expression in the claim of “a non-placeholder bit comprised in the first bit sequence being scrambled by a bit with a same index in the first scrambling sequence” comprises the following meaning: the first scrambling sequence scrambles a non-placeholder bit comprised in the first bit sequence.

In one embodiment, a bit sequence acquired by scrambling a non-placeholder bit comprised in the first bit sequence by a bit with a same index in the first scrambling sequence and a placeholder bit comprised in the first bit sequence through processing are used together to generate the first PUCCH.

In one embodiment, the first bit sequence and the first scrambling sequence are used together to generate the first PUCCH.

In one embodiment, the first bit sequence and the first scrambling sequence generate the first PUCCH after sequentially through Scrambling, Modulation, Spreading, Mapping to physical resources, OFDM baseband signal generation and Modulation and upconversion.

In one embodiment, the first bit sequence and the first scrambling sequence generate the first PUCCH after sequentially through Scrambling, Modulation, Spreading, Mapping to physical resources and OFDM baseband signal generation.

In one embodiment, the first bit sequence and the first scrambling sequence generate the first PUCCH after sequentially through Scrambling, Modulation, Block-wise Spreading, Transform Precoding, Mapping to physical resources, OFDM baseband signal generation and Modulation and upconversion.

In one embodiment, the first bit sequence and the first scrambling sequence generate the first PUCCH after sequentially through Scrambling, Modulation, Block-wise Spreading, Transform Precoding, Mapping to physical resources and OFDM baseband signal generation.

### Embodiment 2

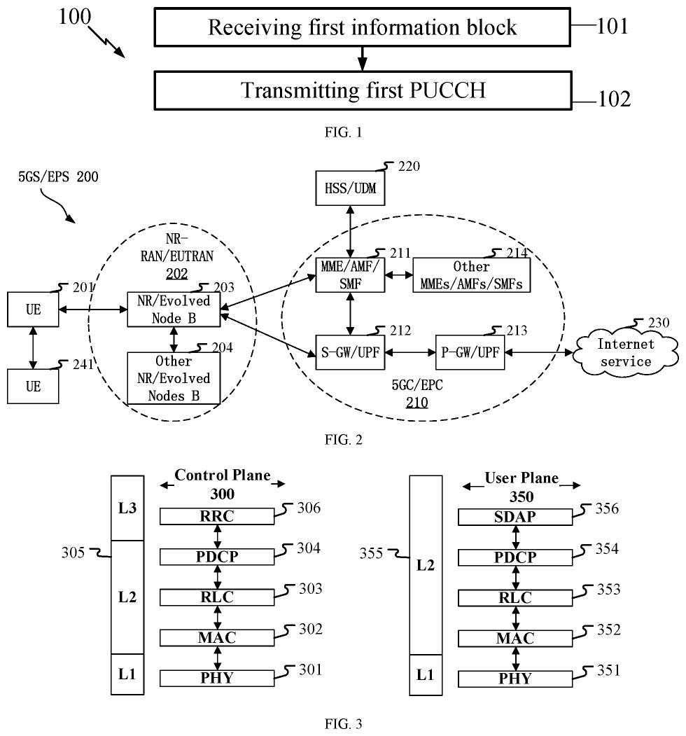

Embodiment 2 illustrates a schematic diagram of a network architecture according to the present application, as shown in FIG. 2. FIG. 2 illustrates a network architecture 200 of 5G NR, Long-Term Evolution (LTE) and Long-Term Evolution Advanced (LTE-A) systems. The 5G NR or LTE network architecture 200 may be called a 5G System (5GS)/Evolved Packet System (EPS) 200 or other appropriate terms. The 5GS/EPS 200 may comprise one or more UEs 201, an NG-RAN 202, a 5G Core Network/Evolved Packet Core (5GC/EPC) 210, a Home Subscriber Server (HSS)/Unified Data Management (UDM) 220 and an Internet Service 230. The 5GS/EPS 200 may be interconnected with other access networks. For simple description, the entities/interfaces are not shown. As shown in FIG. 2, the 5GS/EPS 200 provides packet switching services. Those skilled in the art will readily understand that various concepts presented throughout the present application can be extended to networks providing circuit switching services or other cellular networks. The NG-RAN comprises an NR/evolved node B (gNB/eNB) 203 and other gNBs (eNBs) 204. The gNB(eNB) 203 provides UE 201-oriented user plane and control plane protocol terminations. The gNB(eNB) 203 may be connected to other gNBs (eNBs) 204 via an Xn/X2 interface (e.g., backhaul). The gNB(eNB) 203 may be called a base station, a base transceiver station, a radio base station, a radio transceiver, a transceiver function, a Base Service Set (BSS), an Extended Service Set (ESS), a Transmitter Receiver Point (TRP) or some other applicable terms. The gNB(eNB) 203 provides an access point of the 5GC/EPC 210 for the UE 201. Examples of the UE 201 include cellular phones, smart phones, Session Initiation Protocol (SIP) phones, laptop computers, Personal Digital Assistant (PDA), satellite Radios, non-terrestrial base station communications, Satellite Mobile Communications, Global Positioning Systems (GPSs), multimedia devices, video devices, digital audio players (for example, MP3 players), cameras, game consoles, unmanned aerial vehicles (UAV), aircrafts, narrow-band Internet of Things(IoT) devices, machine-type communication devices, land vehicles, automobiles, wearable devices, test devices, test instrumentation, test tools or any other similar functional devices. Those skilled in the art also can call the UE 201 a mobile station, a subscriber station, a mobile unit, a subscriber unit, a wireless unit, a remote unit, a mobile device, a wireless device, a radio communication device, a remote device, a mobile subscriber station, an access terminal, a mobile terminal, a wireless terminal, a remote terminal, a handset, a user proxy, a mobile client, a client or some other appropriate terms. The gNB(eNB) 203 is connected to the 5GC/EPC 210 via an S1/NG interface. The 5GC/EPC 210 comprises a Mobility Management Entity (MME)/Authentication Management Field (AMF)/Session Management Function (SMF) 211, other MMEs/AMFs/SMFs 214, a Service Gateway (S-GW)/User Plane Function (UPF) 212 and a Packet Date Network Gateway (P-GW)/UPF 213. The MME/AMF/SMF 211 is a control node for processing a signaling between the UE 201 and the 5GC/EPC 210. Generally, the MME/AMF/SMF 211 provides bearer and connection management. All user Internet Protocol (IP) packets are transmitted through the S-GW/UPF 212, the S-GW/UPF 212 is connected to the P-GW/UPF 213. The P-GW provides UE IP address allocation and other functions. The P-GW/UPF 213 is connected to the Internet Service 230. The Internet Service 230 comprises IP services corresponding to operators, specifically including Internet, Intranet, IP Multimedia Subsystem (IMS) and Packet Switching Streaming Services (PSS).

In one embodiment, the UE 201 corresponds to the first node in the present application.

In one embodiment, the UE 201 supports multiplexing transmission of UCIs associated with different priorities.

In one embodiment, the gNB(eNB) 201 corresponds to the second node in the present application.

In one embodiment, the gNB(eNB) 201 supports multiplexing transmission of UCIs associated with different priorities.

### Embodiment 3

Embodiment 3 illustrates a schematic diagram of an example of a radio protocol architecture of a user plane and a control plane according to one embodiment of the present application, as shown in FIG. 3. FIG. 3 is a schematic diagram illustrating an embodiment of aradio protocol architecture of a user plane 350 and a control plane 300. In FIG. 3, the radio protocol architecture for a first node (UE or gNB) and a second node (gNB or UE) is represented by three layers, which are a layer 1, a layer 2 and a layer 3, respectively. The layer 1 (L1) is the lowest layer and performs signal processing functions of various PHY layers. The L1 is called PHY 301 in the present application. The layer 2 (L2) 305 is above the PHY 301, and is in charge of the link between the first node and the second node via the PHY 301. L2 305 comprises a Medium Access Control (MAC) sublayer 302, a Radio Link Control (RLC) sublayer 303 and a Packet Data Convergence Protocol (PDCP) sublayer 304. All the three sublayers terminate at the second node. The PDCP sublayer 304 provides multiplexing among variable radio bearers and logical channels. The PDCP sublayer 304 provides security by encrypting a packet and provides support for a first node handover between second nodes. The RLC sublayer 303 provides segmentation and reassembling of a higher-layer packet, retransmission of a lost packet, and reordering of a data packet so as to compensate the disordered receiving caused by HARQ. The MAC sublayer 302 provides multiplexing between a logical channel and a transport channel. The MAC sublayer 302 is also responsible for allocating between first nodes various radio resources (i.e., resource block) in a cell. The MAC sublayer 302 is also in charge of HARQ operation. The Radio Resource Control (RRC) sublayer 306 in layer 3 (L3) of the control plane 300 is responsible for acquiring radio resources (i.e., radio bearer) and configuring the lower layer with an RRC signaling between a second node and a first node. The radio protocol architecture of the user plane 350 comprises layer 1 (L1) and layer 2 (L2). In the user plane 350, the radio protocol architecture for the first node and the second node is almost the same as the corresponding layer and sublayer in the control plane 300 for physical layer 351, PDCP sublayer 354, RLC sublayer 353 and MAC sublayer 352 in L2 layer 355, but the PDCP sublayer 354 also provides a header compression for a higher-layer packet so as to reduce a radio transmission overhead. The L2 layer 355 in the user plane 350 also includes Service Data Adaptation Protocol (SDAP) sublayer 356, which is responsible for the mapping between QoS flow and Data Radio Bearer (DRB) to support the diversity of traffic. Although not described in FIG. 3, the first node may comprise several higher layers above the L2 layer 355, such as a network layer (e.g., IP layer) terminated at a P-GW of the network side and an application layer terminated at the other side of the connection (e.g., a peer UE, a server, etc.).

In one embodiment, the radio protocol architecture in FIG. 3 is applicable to the first node in the present application.

In one embodiment, the radio protocol architecture in FIG. 3 is applicable to the second node in the present application.

In one embodiment, the first information block in the present application is generated by the RRC 306, or MAC 302, or MAC 352, or the PHY 301, or PHY 351.

In one embodiment, the first PUCCH in the present application is generated by the PHY 301 or the PHY 351.

In one embodiment, the first signaling in the present application is generated by the PHY 301 or the PHY 351.

In one embodiment, the second information block in the present application is generated by the RRC 306, or MAC 302, or MAC 352, or the PHY 301, or PHY 351.

### Embodiment 4

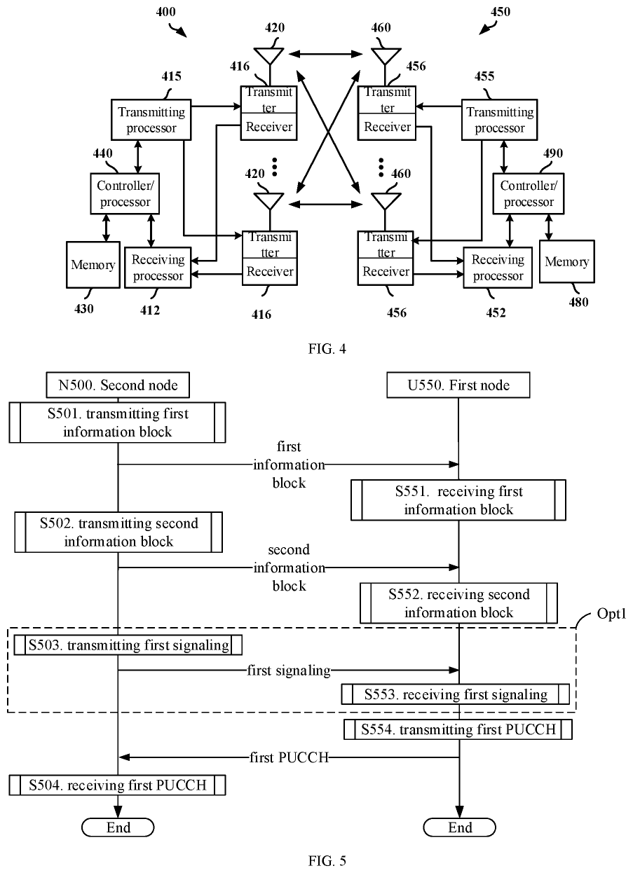

Embodiment 4 illustrates a schematic diagram of a first node and a second node according to one embodiment of the present application, as shown in FIG. 4.

The first node(450) may comprise a controller/processor 490, a data source/buffer 480, a receiving processor 452, a transmitter/receiver 456 and a transmitting processor 455, wherein the transmitter/receiver 456 comprises an antenna 460.

The second node (410) may comprise a controller/processor 440, a data source/buffer 430, a receiving processor 412, a transmitter/receiver 416 and a transmitting processor 415, wherein the transmitter/receiver 416 comprises an antenna 420.

In DL (Downlink), a higher-layer packet, such as higher-layer information carried by the first information block and the second information block in the present application (when the first information block comprises higher-layer information) is provided to the controller/processor 440. The controller/processor 440 implements the functionality of the L2 layer and the higher layer. In DL transmission, the controller/processor 440 provides header compression, encryption, packet segmentation and reordering and multiplexing between a logical channel and a transport channel, as well as radio resource allocation for the first node 450 based on varied priorities. The controller/processor 440 is also in charge of HARQ operation, retransmission of a lost packet, and a signaling to the first node 450, for instance, higher-layer information comprised in the first information block and the second information block in the present application are all generated in the controller/processor 440. The transmitting processor 415 provides various signal-processing functions for the L1 layer (that is, PHY), including coding, interleaving, scrambling, modulating, power control/allocation, precoding and generation of physical-layer control signaling, such as the generation of a physical-layer signal carrying the first information block and the second information block and the first signaling are completed at the transmitter 415. The generated modulation symbols are divided into parallel streams and each stream is mapped onto a corresponding multicarrier subcarrier and/or a multicarrier symbol, which is later mapped from the transmitting processor 415 to the antenna 420 via the transmitter 416 in the form of a radio frequency signal. At the receiving side, each receiver 456 receives an RF signal via a corresponding antenna 460, each receiver 456 recovers baseband information modulated to the RF carrier and provides the baseband information to the receiving processor 452. The receiving processor 452 provides various signal receiving functions for the L1 layer. The signal receiving processing function includes a reception of a physical-layer signal carrying the first information block and a physical-layer signal carrying the second information block as well as areception of afirst signaling. Multicarrier symbols in multicarrier symbol streams are demodulated based on varied modulation schemes (i.e., BPSCK, QPSK), and are then de-scrambled, decoded and de-interleaved to recover data or control signal transmitted by the second node 410 on a physical channel. And after that the data and control signal are provided to the controller/processor 490. The controller/processor 490 is in charge of the function of L2 layer and above layers, and the controller/processor 490 interprets higher-layer information comprised in the first information block and higher-layer information carried by the second information block in the present application. The controller/processor can be connected to a memory 480 that stores program code and data. The memory 480 may be called a computer readable medium.

In uplink (UL) transmission, similar to downlink transmission, higher-layer information is generated at the controller/processor 490 and then through the transmitting processor 455 to implement various signal transmission processing functions for the L1 layer (i.e., the physical layer). The first PUCCH in the present application is generated at the transmitting processor 455 and then mapped to the antenna 460 through the transmitter 456 by the transmitting processor 455 to be transmitted in the form of an RF signal. The receiver 416 receives a radio-frequency signal via its corresponding antenna 420, and each receiver 416 recovers baseband information modulated to a radio-frequency carrier, and supplies the baseband information to the receiving processor 412. The receiving processor 412 implements various signal reception and processing functions for the L1 layer (i.e., the physical layer), including receiving and processing the physical-layer signal of the first PUCCH in the present application, and then providing data and/or control signals to the controller/processor 440. The controller/processor 440 performs functions of L2 layer, including interpreting higher-layer information. The controller/processor can be connected to a buffer 430 that stores program code and data. The buffer 430 may be called a computer readable medium.

In one embodiment, the first node 450 comprises at least one processor and at least one memory. The at least one memory comprises computer program codes; the at least one memory and the computer program codes are configured to be used in collaboration with the at least one processor. The first node 450 at least: receives a first information block, the first information block is used to determine a first parameter value, the first parameter value is used to generate a first scrambling sequence, the first parameter value being a non-negative integer, the first scrambling sequence comprises multiple sequentially indexed bits; and transmits a first PUCCH, the first PUCCH is used to carry a first bit block and a second bit block, the first bit block comprises at least one control information bit, and the second bit block comprises at least one control information bit; herein, a number of control information bit(s) comprised in the first bit block is not greater than 2; a sum of a number of control information bit(s) comprised in the first bit block and a number of control information bit(s) comprised in the second bit block is greater than 2; a priority index of a control information bit comprised in the first bit block is equal to a first priority index, a priority index of a control information bit comprised in the second bit block is equal to a second priority index, and the first priority index is not equal to the second priority index; the first bit block and the second bit block are used together to generate a first bit sequence, and the first bit sequence comprises multiple sequentially indexed bits; the first bit sequence comprises at least one placeholder bit, a non-placeholder bit comprised in the first bit sequence is scrambled by a bit with a same index in the first scrambling sequence.

In one embodiment, the first node 450 comprises a memory that stores a computer readable instruction program. The computer readable instruction program generates an action when executed by at least one processor. The action includes: receiving a first information block, the first information block being used to determine a first parameter value, the first parameter value being used to generate a first scrambling sequence, the first parameter value being a non-negative integer, the first scrambling sequence comprising multiple sequentially indexed bits; and transmitting a first PUCCH, the first PUCCH being used to carry a first bit block and a second bit block, the first bit block comprising at least one control information bit, and the second bit block comprising at least one control information bit; herein, a number of control information bit(s) comprised in the first bit block is not greater than 2; a sum of a number of control information bit(s) comprised in the first bit block and a number of control information bit(s) comprised in the second bit block is greater than 2; a priority index of a control information bit comprised in the first bit block is equal to a first priority index, a priority index of a control information bit comprised in the second bit block is equal to a second priority index, and the first priority index is not equal to the second priority index; the first bit block and the second bit block are used together to generate a first bit sequence, and the first bit sequence comprises multiple sequentially indexed bits; the first bit sequence comprises at least one placeholder bit, a non-placeholder bit comprised in the first bit sequence is scrambled by a bit with a same index in the first scrambling sequence.

In one embodiment, the second node 410 comprises at least one processor and at least one memory. The at least one memory comprises computer program codes; the at least one memory and the computer program codes are configured to be used in collaboration with the at least one processor. The second node 410 at least: transmits a first information block, the first information block is used to indicate a first parameter value, the first parameter value is used to generate a first scrambling sequence, the first parameter value is a non-negative integer, the first scrambling sequence comprises multiple sequentially indexed bits; receives a first PUCCH, the first PUCCH is used to carry a first bit block and a second bit block, the first bit block comprises at least one control information bit, and the second bit block comprises at least one control information bit; herein, a number of control information bit(s) comprised in the first bit block is not greater than 2; a sum of a number of control information bit(s) comprised in the first bit block and a number of control information bit(s) comprised in the second bit block is greater than 2; a priority index of a control information bit comprised in the first bit block is equal to a first priority index, a priority index of a control information bit comprised in the second bit block is equal to a second priority index, and the first priority index is not equal to the second priority index; the first bit block and the second bit block are used together to generate a first bit sequence, and the first bit sequence comprises multiple sequentially indexed bits; the first bit sequence comprises at least one placeholder bit, a non-placeholder bit comprised in the first bit sequence is scrambled by a bit with a same index in the first scrambling sequence.

In one embodiment, the second node 410 comprises a memory that stores a computer readable instruction program. The computer readable instruction program generates an action when executed by at least one processor. The action includes: transmitting a first information block, the first information block being used to indicate a first parameter value, the first parameter value being used to generate a first scrambling sequence, the first parameter value being a non-negative integer, the first scrambling sequence comprising multiple sequentially indexed bits; receiving a first PUCCH, the first PUCCH being used to carry a first bit block and a second bit block, the first bit block comprising at least one control information bit, and the second bit block comprising at least one control information bit; herein, a number of control information bit(s) comprised in the first bit block is not greater than 2; a sum of a number of control information bit(s) comprised in the first bit block and a number of control information bit(s) comprised in the second bit block is greater than 2; a priority index of a control information bit comprised in the first bit block is equal to a first priority index, a priority index of a control information bit comprised in the second bit block is equal to a second priority index, and the first priority index is not equal to the second priority index; the first bit block and the second bit block are used together to generate a first bit sequence, and the first bit sequence comprises multiple sequentially indexed bits; the first bit sequence comprises at least one placeholder bit, a non-placeholder bit comprised in the first bit sequence is scrambled by a bit with a same index in the first scrambling sequence.

In one embodiment, the first node 450 is a UE.

In one embodiment, the first node 450 is a UE supporting multiplexing transmission of information associated with different priorities.

In one embodiment, the second node 410 is a base station (gNB/eNB).

In one embodiment, the second node 410 is a base station supporting multiplexing transmission of information associated with different priorities.

In one embodiment, the receiver 456 (including the antenna 460), the receiving processor 452 and the controller/processor 490 are used to receive the first information block in the present application.

In one embodiment, the transmitter 456 (including the antenna 460), and the transmitting processor 455 are used to transmit the first PUCCH in the present application.

In one embodiment, the receiver 456 (including the antenna 460), the receiving processor 452 and the controller/processor 490 are used to receive the second information block in the present application.

In one embodiment, the receiver 456 (including the antenna 460) and the receiving processor 452 are used to receive the first signaling in the present application.

In one embodiment, the transmitter 416 (including the antenna 420), the transmitting processor 415 and the controller/processor 440 are used to transmit the first information block in the present application.

In one embodiment, the receiver 416 (including the antenna 420) and the receiving processor 412 are used to receive first PUCCH in the present application.

In one embodiment, the transmitter 416 (including the antenna 420), the transmitting processor 415 and the controller/processor 440 are used to transmit the second information block in the present application.

In one embodiment, the transmitter 416 (including the antenna 420) and the transmitting processor 415 are used to transmit the first signaling in the present application.

### Embodiment 5

Embodiment 5 illustrates a flowchart of radio signal transmission according to one embodiment in the present application, as shown in FIG. 5. In FIG. 5, a second node N500 is a maintenance base station of a serving cell of a first node U550, and the step in the dotted box Opt1 represents an optional step. It is particularly underlined that the order illustrated in the embodiment does not put constraints over sequences of signal transmissions and implementations.

The second node N500 transmits a first information block in step S501, transmits a second information block in step S502, transmits a first signaling in step S503, and receives a first PUCCH in step S504.

The first node U550 receives a first information block in step S551, receives a second information block in step S552, receives a first signaling in step S553, and transmits a first PUCCH in step S554.

In embodiment 5, the first information block is used to determine a first parameter value, the first parameter value is used to generate a first scrambling sequence, the first parameter value is a non-negative integer, the first scrambling sequence comprises multiple sequentially indexed bits; the first PUCCH is used to carry a first bit block and a second bit block, the first bit block comprises at least one control information bit, and the second bit block comprises at least one control information bit; a number of control information bit(s) comprised in the first bit block is not greater than 2; a sum of a number of control information bit(s) comprised in the first bit block and a number of control information bit(s) comprised in the second bit block is greater than 2; a priority index of a control information bit comprised in the first bit block is equal to a first priority index, a priority index of a control information bit comprised in the second bit block is equal to a second priority index, and the first priority index is not equal to the second priority index; the first bit block and the second bit block are used together to generate a first bit sequence, and the first bit sequence comprises multiple sequentially indexed bits; the first bit sequence comprises at least one placeholder bit, a non-placeholder bit comprised in the first bit sequence is scrambled by a bit with a same index in the first scrambling sequence; the second information block is used to determine X1 resource sets, X1 being a positive integer greater than 1; any of the X1 resource sets comprises at least one PUCCH resource, resources occupied by the first PUCCH belong to a target PUCCH resource, and the target PUCCH resource is a PUCCH resource comprised in a target resource set; the target resource set is one of the X1 resource sets, and a target number value is used to determine the target resource set out of the X1 resource sets, the target number value being a positive integer; at least one of a number of control information bit(s) comprised in the first bit block, or a number of control information bit(s) comprised in the second bit block is used to determine the target number value; when the target resource set comprises more than one PUCCH resource, the first signaling is used to determine the target PUCCH resource from the target resource set.

In one embodiment, the second information is transmitted via an air interface or a radio interface.

In one embodiment, the second information block comprises all or part of a higher-layer signaling or physical-layer signaling.

In one embodiment, the second information block comprises all or part of a Radio Resource Control (RRC)-layer signaling or a Medium Access Control (MAC) layer signaling.

In one embodiment, the second information block comprises all or part of a System Information Block (SIB).

In one embodiment, the second information block is cell-specific or UE-specific.

In one embodiment, the second information block is Per Bandwidth Part (BWP) Configured.

In one embodiment, the second information block comprises all or partial fields of a DCI signaling.

In one embodiment, the second information comprises a priority indicator field in a DCI format.

In one embodiment, the first information block and the second information block are two different IEs in a same RRC-layer signaling.

In one embodiment, the first information block and the second information block are two different fields in a same IE.

In one embodiment, the first information block and the second information block are two different fields in a same DCI format.

In one embodiment, the second information block comprises more than one sub-information block, and each sub-information block comprised in the first information block is an IE or a field in an RRC signaling to which the second information block belongs; one or multiple sub-information blocks comprised in the second information block is used to determine the X1 resource sets.

In one embodiment, the second information block comprises all or partial fields in an IE “PUCCH-Config” in an RRC signaling.

In one embodiment, the second information block comprises all or partial fields in an IE “PDSCH-Config” in an RRC signaling.

In one embodiment, the second information block comprises all or partial fields in an IE “PUCCH-ConfigCommon” in an RRC signaling.

In one embodiment, the second information block comprises all or partial fields in an IE “BWP-UplinkDedicated” in an RRC signaling.

In one embodiment, the second information block comprises all or partial fields in an IE “pucch-ConfigurationList” in an RRC signaling.

In one embodiment, the second information block comprises all or partial fields in a second “PUCCH-Config” IE in an IE “pucch-ConfigurationList”.

In one embodiment, the second information block comprises all or partial fields in a “PUCCH-Config”IE corresponding to priority index “1” in an Information Element (IE) “pucch-ConfigurationList” in an RRC signaling.

In one embodiment, the second information block comprises all or partial fields in a “PUCCH-Config”IE corresponding to priority index “0” in an Information Element (IE) “pucch-ConfigurationList” in an RRC signaling.

In one embodiment, the second information block comprises all or partial fields in a “PUCCH-Config”IE corresponding to a large priority index in an Information Element (IE) “pucch-ConfigurationList” in an RRC signaling.

In one embodiment, the second information block comprises all or partial fields in a “PUCCH-Config”IE corresponding to a small priority index in an Information Element (IE) “pucch-ConfigurationList” in an RRC signaling.

In one embodiment, the expression of “the second information block being used to determine X1 resource sets” in the claim comprises the following meaning: the second information block is used by the first node in the present application to determine the X1 resource sets.

In one embodiment, the expression of “the second information block being used to determine X1 resource sets” in the claim comprises the following meaning: the second information block is used to explicitly or implicitly indicate the X1 resource sets.

In one embodiment, the expression of “the second information block being used to determine X1 resource sets” in the claim comprises the following meaning: one or multiple fields comprised in the second information block is used to explictly or implicitly indicate the X1 resource sets.

In one embodiment, the first signaling is transmitted via an air interface or a radio interface.

In one embodiment, the first signaling comprises all or part of a higher-layer signaling or physical-layer signaling.

In one embodiment, the first signaling comprises all or part of a Radio Resource Control (RRC)-layer signaling or a Medium Access Control (MAC)-layer signaling.

In one embodiment, the first signaling is cell-specific or UE-specific.

In one embodiment, the first signaling is Per Bandwidth Part (BWP) Configured.

In one embodiment, the first signaling comprises all or partial fields of a Downlink Control Information (DCI) signaling.

In one embodiment, the first signaling comprises a PUCCH Resource Indicator (PRI) in a Downlink Control Information (DCI) format.

In one embodiment, the first signaling is carried through a PDCCH.

In one embodiment, the first signaling is carried through a latest PDCCH associated with the first PUCCH.

In one embodiment, the expression of “the first signaling being used to determine the target PUCCH resource from the target resource set” in the claim comprises the following meaning: the first signaling is used by the first node in the present application to determine the target PUCCH resource from the target resource set.

In one embodiment, the expression of “the first signaling being used to determine the target PUCCH resource from the target resource set” in the claim comprises the following meaning: the first signaling is used to explicitly or implicitly indicate the target PUCCH resource from the target resource set.

In one embodiment, the expression of “the first signaling being used to determine the target PUCCH resource from the target resource set” in the claim comprises the following meaning: the first signaling is used to explicitly or implicitly indicate an index or an ID of the target PUCCH resource in the target resource set.

In one embodiment, the expression of “the first signaling being used to determine the target PUCCH resource from the target resource set” in the claim comprises the following meaning: a PRI field carried by the first signaling and an index of a starting CCE occupied by a PDCCH carrying the first signaling are used together to determine an index or an ID of the target PUCCH resource in the target resource set.

### Embodiment 6

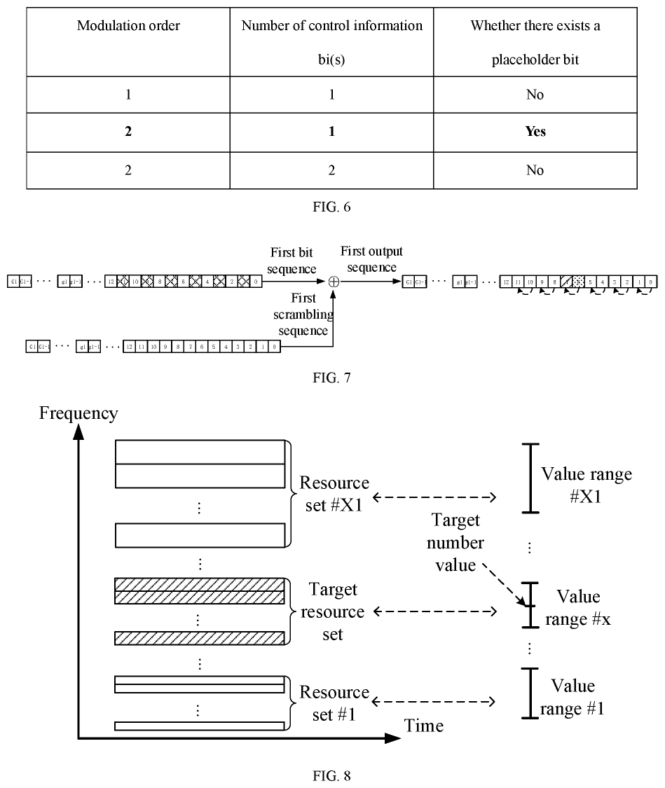

Embodiment 6 illustrate a schematic diagram of a relation between a first modulation order and a first bit block according to one embodiment of the present application, as shown in FIG. 6. In FIG. 6, the first column from the left represents the modulation order, the second column from the left represents a number of control information bit(s), the third column from the left represents whether there exist occupying bits, and the rows highlighted in black respectively represent a first order and a number of control information bit(s) comprised in a first bit block.

In embodiment 6, a modulation order of a modulation method adopted by the first PUCCH in the present application is equal to a first modulation order, and the first modulation order is a positive integer greater than 11; a number of control information bit(s) comprised in the first bit block in the present application being less than the first modulation order is used to determine that the first bit sequence comprises at least one placeholder bit.

In one embodiment, a modulation method adopted by the first PUCCH is QPSK.

In one embodiment, a modulation method adopted by the first PUCCH is 16QAM.

In one embodiment, when a modulation method adopted by the first PUCCH is QPSK, the first modulation order is equal to 2.

In one embodiment, when a modulation method adopted by the first PUCCH is 16QAM, the first modulation order is equal to 4.

In one embodiment, the first order number is equal to a positive integer power of 2.

In one embodiment, the first modulation order is equal to one of 2, 4, 8, or 16.

In one embodiment, the expression in the claim of “a number of control information bit(s) comprised in the first bit block being less than the first order number being used to determine that the first bit sequence comprises at least one placeholder bit” comprises the following meaning: a number of control information bit(s) comprised in the first bit block being less than the first modulation order is used by the first node in the present application to determine that the first bit sequence comprises at least one placeholder bit.

In one embodiment, the expression in the claim of “a number of control information bit(s) comprised in the first bit block being less than the first order number being used to determine that the first bit sequence comprises at least one placeholder bit” comprises the following meaning: only when a number of control information bit(s) comprised in the first bit block is less than the first order number, the first bit sequence comprises at least one placeholder bit.

In one embodiment, the expression in the claim of “a number of control information bit(s) comprised in the first bit block being less than the first order number being used to determine that the first bit sequence comprises at least one placeholder bit” comprises the following meaning: when a number of control information bit(s) comprised in the first bit block is greater than or equal to the first order number, the first bit sequence does not comprise any placeholder bit.

In one embodiment, the expression in the claim of “a number of control information bit(s) comprised in the first bit block being less than the first order number being used to determine that the first bit sequence comprises at least one placeholder bit” comprises the following meaning: when a number of control information bit(s) comprised in the first bit block is less than the first order number, the first bit sequence comprises at least one placeholder bit; when a number of control information bit(s) comprised in the first bit block is greater than or equal to the first order number, the first bit sequence does not comprise any placeholder bit.

In one embodiment, the expression in the claim of “a number of control information bit(s) comprised in the first bit block being less than the first order number being used to determine that the first bit sequence comprises at least one placeholder bit” comprises the following meaning: a number of control information bit(s) comprised in the first bit block is less than the first order number.

### Embodiment 7

Embodiment 7 illustrates a schematic diagram of a relation between a first bit and a second bit according to one embodiment of the present application, as shown in FIG. 7. In FIG. 7, each small grid represents one bit, each cross-line-filled small grid represents a placeholder bit in a first bit sequence, the slash-filled small grid represents a first bit, the dot-filled small grid represents a second bit, and the arrow represents that bit values are equal.

In embodiment 7, the first bit sequence in the present application and the first scrambling sequence in the present application are used together to generate a first output sequence, the first output sequence comprises multiple sequentially indexed bits, and a number of bits comprised in the first output sequence is equal to a number of bits comprised in the first bit sequence; a first index is an index of a placeholder bit comprised in the first bit sequence, a bit with index equal to the first index comprised in the first output sequence is a first bit, a second bit is a bit comprised in the first output sequence, the second index is an index of the second bit in the first output sequence, the second index and the first index are two adjacent indexes, and a bit value of the first bit is equal to a bit value of the second bit.

In one embodiment, the first output sequence is a bit sequence acquired after the first bit sequence through scrambling.

In one embodiment, the first output sequence is used to generate the first PUCCH.

In one embodiment, the first output sequence generates the first PUCCH after sequentially through Modulation, Spreading, Mapping to physical resources, OFDM baseband signal generation and Modulation and upconversion.

In one embodiment, the first output sequence generates the first PUCCH after sequentially through Modulation, Spreading, Mapping to physical resources and OFDM baseband signal generation.

In one embodiment, the first output sequence generates the first PUCCH after sequentially through Modulation, Block-wise Spreading, Transform Precoding, Mapping to physical resources, OFDM baseband signal generation and Modulation and upconversion.

In one embodiment, the first output sequence generates the first PUCCH after sequentially through Modulation, Block-wise Spreading, Transform Precoding, Mapping to physical resources and OFDM baseband signal generation.

In one embodiment, the expression of “the first bit sequence and the first scrambling sequence being used together to generate a first output sequence” in the claim comprises the following meaning: the first bit sequence and the first scrambling sequence are used together by the first node in the present application to generate the first output sequence.

In one embodiment, the expression of “the first bit sequence and the first scrambling sequence being used together to generate a first output sequence” in the claim comprises the following meaning: the first scrambling sequence scrambling a non-placeholder bit comprised in the first bit sequence is used to generate the first output sequence.

In one embodiment, the expression of “the first bit sequence and the first scrambling sequence being used together to generate a first output sequence” in the claim comprises the following meaning: the first scrambling sequence and a non-placeholder bit comprised in the first bit sequence perform corresponding Logic AND operation of bit, and then the placeholder bit repeats a previously indexed bit value to acquire the first output sequence.

In one embodiment, the first index is an index of a placeholder bit comprised in the first bit sequence in the first bit sequence.

In one embodiment, the first index can be an index of any placeholder bit comprised in the first bit sequence in the first bit sequence.

In one embodiment, an index of the first bit in the first output sequence is equal to the first index.

In one embodiment, the first bit is a bit in the first output sequence corresponding to a placeholder bit.

In one embodiment, the second bit is a bit in the first output sequence corresponding to a non-placeholder bit.

In one embodiment, a bit value of the second bit is equal to a result of logical AND between a bit value of a bit comprised in the first bit sequence and a bit value of a bit comprised in the first scrambling sequence.

In one embodiment, the second bit is equal to a result of Logical AND between a bit value of a bit with an index equal to the second index comprised in the first bit sequence and a bit value of a bit with an index equal to the second index comprised in the first scrambling sequence.

In one embodiment, the expression in the claim of “the first index and the first index are two adjacent indexes” comprises the following meaning: the second index is equal to the first index minus 1.

In one embodiment, the expression in the claim of “the first index and the first index are two adjacent indexes” comprises the following meaning: the second index is equal to the first index plus 1.

In one embodiment, the expression in the claim of “the first index and the first index are two adjacent indexes” comprises the following meaning: the second index and first index are indexes of two adjacent bits in the first output sequence.

In one embodiment, the expression in the claim of “the first index and the first index are two adjacent indexes” comprises the following meaning: the second index is an index prior to the first index.

In one embodiment, the expression in the claim of “the first index and the first index are two adjacent indexes” comprises the following meaning: the second index is an index later than the first index.

### Embodiment 8

Embodiment 8 illustrates a schematic diagram of a relation between a target number value and a target resource set according to one embodiment of the present application, as shown in FIG. 8. In FIG. 8, the horizontal axis represents time, the vertical axis represents frequency, and each rectangle represents one PUCCH resource comprised in X1 resource sets, each slash-filled rectangle represents one PUCCH resource comprised in a target resource set, each line end on the right represents a numerical range, and a target number value belongs to a numerical range.

In embodiment 8, the second information block in the present application is used to determine X1 resource sets, X1 being a positive integer greater than 1; any of the X1 resource sets comprises at least one PUCCH resource, a resource occupied by the first PUCCH in the present application belong to a target PUCCH resource, and the target PUCCH resource is a PUCCH resource comprised in a target resource set; the target resource set is one of the X1 resource sets, and a target number value is used to determine the target resource set out of the X1 resource sets, the target number value being a positive integer; at least one of a number of control information bit(s) comprised in the first bit block in the present application, or a number of control information bit(s) comprised in the second bit block in the present application is used to determine the target number value.

In one embodiment, any of the X1 resource sets is a PUCCH resource set.

In one embodiment, any of the X1 resource sets comprises that any PUCCH resource comprises at least one of frequency-domain resources, time-domain resources or code-domain resources.

In one embodiment, any of the X1 resource sets comprises that any PUCCH resource comprises at least one of frequency-domain resources, time-domain resources or sequence resources.

In one embodiment, resources occupied by the first PUCCH is the target PUCCH resource.

In one embodiment, resources occupied by the first PUCCH is a part of the target PUCCH resource.

In one embodiment, the target PUCCH resource only comprises resources occupied by the first PUCCH.

In one embodiment, the first target PUCCH resource also comprise resources other than resources occupied by the first PUCCH.

In one embodiment, resources occupied by the PUCCH comprise at least one frequency-domain resources, time-domain resources or code-domain resources.

In one embodiment, resources occupied by the PUCCH comprise at least one frequency-domain resources, time-domain resources or sequence resources.

In one embodiment, the expression of “a target number value being used to determine the target resource set from the X1 resource sets” in the claim comprises the following meaning: the target number value is used by the first node in the present application to determine the target resource set from the X1 resource sets.

In one embodiment, the expression of “a target number value being used to determine the target resource set from the X1 resource sets” in the claim comprises the following meaning: the target number value is used to determine the target resource set from the X1 resource sets according to a corresponding relation.

In one embodiment, the expression of “a target number value being used to determine the target resource set from the X1 resource sets” in the claim comprises the following meaning: the target number value is used to determine the target resource set from the X1 resource sets according to a mapping relation.

In one embodiment, the expression of “a target number value being used to determine the target resource set from the X1 resource sets” in the claim comprises the following meaning: the X1 resource sets respectively correspond to X1 value ranges, the target number value belongs to a target value range, the target value range is one of the X1 value ranges, and the target resource set is a resource set corresponding to the target value range among the X1 resource sets. In one subsidiary embodiment of the above embodiment, the X1 value ranges are configurable. In one subsidiary embodiment of the above embodiment, the X1 value ranges are pre-defined. In one subsidiary embodiment of the above embodiment, the X1 value ranges are configured by one or multiple fields comprised in the second information block.

In one embodiment, the expression in the claim of “at least one of a number of control information bit(s) comprised in the first bit block, or a number of control information bit(s) comprised in the second bit block being used to determine the target number value” comprises the following meaning: at least one of a number of control information bit(s) comprised in the first bit block, or a number of control information bit(s) comprised in the second bit block is used by the first node in the present application to determine the target number value.

In one embodiment, the expression in the claim of “at least one of a number of control information bit(s) comprised in the first bit block, or a number of control information bit(s) comprised in the second bit block being used to determine the target number value” comprises the following meaning: a number of control information bit(s) comprised in the first bit block is used to determine the target number value.

In one embodiment, the expression in the claim of “at least one of a number of control information bit(s) comprised in the first bit block, or a number of control information bit(s) comprised in the second bit block being used to determine the target number value” comprises the following meaning: a number of control information bit(s) comprised in the second bit block is used to determine the target number value.

In one embodiment, the expression in the claim of “at least one of a number of control information bit(s) comprised in the first bit block, or a number of control information bit(s) comprised in the second bit block being used to determine the target number value” comprises the following meaning: both a number of control information bit(s) comprised in the first bit block and a number of control information bit(s) comprised in the second bit block is used to determine the target number value.

In one embodiment, the expression in the claim of “at least one of a number of control information bit(s) comprised in the first bit block, or a number of control information bit(s) comprised in the second bit block being used to determine the target number value” comprises the following meaning: the target number value is equal to a number of control information bit(s) comprised in the first bit block.

In one embodiment, the expression in the claim of “at least one of a number of control information bit(s) comprised in the first bit block, or a number of control information bit(s) comprised in the second bit block being used to determine the target number value” comprises the following meaning: the target number value is equal to a number of control information bit(s) comprised in the second bit block.

In one embodiment, the expression in the claim of “at least one of a number of control information bit(s) comprised in the first bit block, or a number of control information bit(s) comprised in the second bit block being used to determine the target number value” comprises the following meaning: the target number value is equal to a sum of a number of control information bit(s) comprised in the first bit block and a number of control information bit(s) comprised in the second bit block.

In one embodiment, the expression in the claim of “at least one of a number of control information bit(s) comprised in the first bit block, or a number of control information bit(s) comprised in the second bit block being used to determine the target number value” comprises the following meaning: the target number value is equal to a number of control information bit(s) comprised in a bit block with a greater priority index in the first bit block and the second bit block.

In one embodiment, the expression in the claim of “at least one of a number of control information bit(s) comprised in the first bit block, or a number of control information bit(s) comprised in the second bit block being used to determine the target number value” comprises the following meaning: the second bit block is used to generate a fourth bit block, and the target number value is equal to a sum of a number of control information bit(s) comprised in the first bit block and a number of bit(s) comprised in the fourth bit block.

In one embodiment, the expression in the claim of “at least one of a number of control information bit(s) comprised in the first bit block, or a number of control information bit(s) comprised in the second bit block being used to determine the target number value” comprises the following meaning: the second bit block is used to generate a fourth bit block, a number of control information bit(s) comprised in the second bit block is used to determine a number of bit(s) comprised in the fourth bit block, and the target number value is equal to a sum of a number of control information bit(s) comprised in the first bit block and a number of bit(s) comprised in the fourth bit block.

In one embodiment, the expression in the claim of “at least one of a number of control information bit(s) comprised in the first bit block, or a number of control information bit(s) comprised in the second bit block being used to determine the target number value” comprises the following meaning: the second bit block is used to generate a fourth bit block, and a number of bit(s) comprised in the fourth bit block is less than a number of control information bit(s) comprised in the second bit block; the target number value is equal to a sum of a number of control information bit(s) comprised in the first bit block and a number of bit(s) comprised in the fourth bit block.

### Embodiment 9

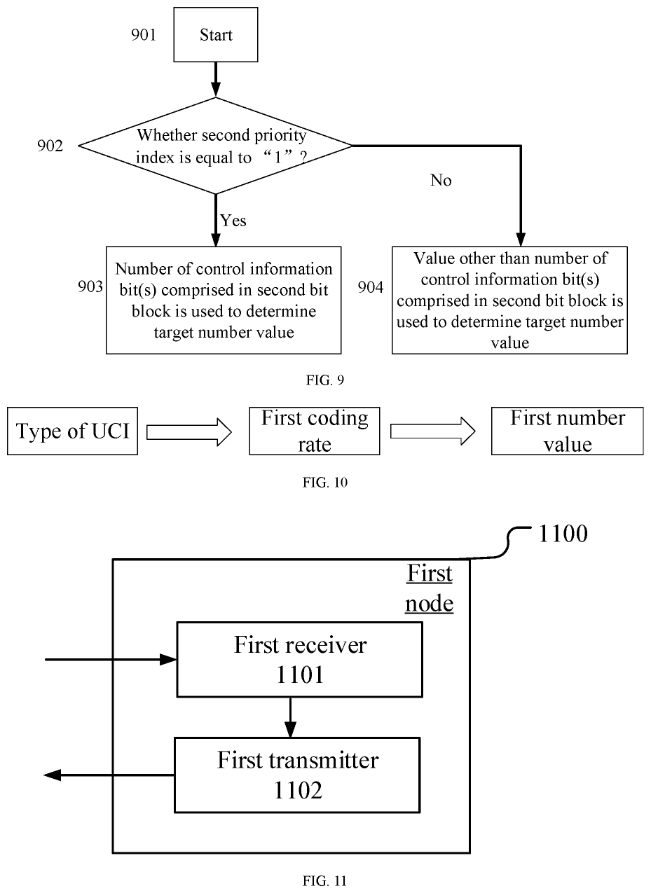

Embodiment 9 illustrates a schematic diagram of arelation between a target number value and a second priority index according to one embodiment of the present application, as shown in FIG. 9. In FIG. 9, starting from 901, in 902, whether a second priority index is equal to “1”, in 903, a number of control information bit(s) comprised in a second bit block is used to determine a target number value, and in 904, a value other than a number of control information bit(s) comprised in a second bit block is used to determine a target number value.

In embodiment 9, whether a number of control information bit(s) comprised in the second bit block in the present application is used to determine that the target number value in the present application is related to the second priority index in the present application.

In one embodiment, the expression in the claim of “whether a number of control information bit(s) comprised in the second bit block is used to determine the target number value is related to the second priority index” comprises the following meaning: when the second priority index is equal to 1, a number of control information bit(s) comprised in the second bit block is used to determine the target number value; when the second priority index is equal to 0, a number of control information bit(s) comprised in the second bit block is not used to determine the target number value.

In one embodiment, the expression in the claim of “whether a number of control information bit(s) comprised in the second bit block is used to determine the target number value is related to the second priority index” comprises the following meaning: when the second priority index is equal to 0, a number of control information bit(s) comprised in the second bit block is used to determine the target number value; when the second priority index is equal to 1, a number of control information bit(s) comprised in the second bit block is not used to determine the target number value.

In one embodiment, the expression in the claim of “whether a number of control information bit(s) comprised in the second bit block is used to determine the target number value is related to the second priority index” comprises the following meaning: when the second priority index is greater than the first priority index, a number of control information bit(s) comprised in the second bit block is used to determine the target number value; when the second priority index is less than the first priority index, a number of control information bit(s) comprised in the second bit block is not used to determine the target number value.

In one embodiment, the expression in the claim of “whether a number of control information bit(s) comprised in the second bit block is used to determine the target number value is related to the second priority index” comprises the following meaning: when the second priority index is less than the first priority index, a number of control information bit(s) comprised in the second bit block is used to determine the target number value; when the second priority index is greater than the first priority index, a number of control information bit(s) comprised in the second bit block is not used to determine the target number value.

In one embodiment, the expression in the claim of “whether a number of control information bit(s) comprised in the second bit block is used to determine the target number value is related to the second priority index” comprises the following meaning: when the second priority index is equal to 1, a number of control information bit(s) comprised in the second bit block is used to determine the target number value; when the second priority index is equal to 0 and a number of control information bit(s) comprised in the second bit block is greater than a first threshold, the first threshold is used to determine the target number value. In one subsidiary embodiment of the above embodiment, the first threshold is configurable. In one subsidiary embodiment of the above embodiment, the first threshold is predefined.

In one embodiment, the expression in the claim of “whether a number of control information bit(s) comprised in the second bit block is used to determine the target number value is related to the second priority index” comprises the following meaning: when the second priority index is equal to 1, a number of control information bit(s) comprised in the second bit block is used to determine the target number value; when the second priority index is equal to 0 and a number of control information bit(s) comprised in the second bit block is greater than a first threshold, the first threshold is used to determine the target number value; when the second priority index is equal to 0 and a number of control information bit(s) comprised in the second bit block is not greater than a first threshold, a number of control information bit(s) comprised in the second bit block is used to determine the target number value. In one subsidiary embodiment of the above embodiment, the first threshold is configurable. In one subsidiary embodiment of the above embodiment, the first threshold is predefined.

In one embodiment, the expression in the claim of “whether a number of control information bit(s) comprised in the second bit block is used to determine the target number value is related to the second priority index” comprises the following meaning: when the second priority index is equal to 1, the target number value is equal to a sum of a number of control information bit(s) comprised in the first bit block and a number of control information bit(s) comprised in the second bit block; when the second priority index is equal to 0 and a number of control information bit(s) comprised in the second bit block is greater than a first threshold, the target number value is equal to a sum of a number of control information bit(s) comprised in the first bit block and the first threshold; when the second priority index is equal to 0 and a number of control information bit(s) comprised in the second bit block is not greater than a first threshold, the target number value is equal to a sum of a number of control information bit(s) comprised in the first bit block and a number of control information bit(s) comprised in the second bit block. In one subsidiary embodiment of the above embodiment, the first threshold is configurable. In one subsidiary embodiment of the above embodiment, the first threshold is predefined.

### Embodiment 10

Embodiment 10 illustrates a schematic diagram of a first number value according to one embodiment of the present application, as shown in FIG. 10. In FIG. 10, each rectangle box represents a variable or state, and the arrow represents a determination relation.

In embodiment 10, the second information block in the present application is used to determine a first coding rate, and the first coding rate is a non-negative number; a number of PRB(s) occupied by the first PUCCH in the present application is equal to a first number value; the first coding rate is used to determine the first number value, and a number of bit(s) comprised in the first bit sequence in the present application is directly proportional to the first number value; a type of a UCI carried by the first PUCCH is used to determine the first coding rate.

In one embodiment, the expression of “the second information block being used to determine a first coding rate” in the claim comprises the following meaning: the second information block is used by the first node in the present application to determine the first coding rate.

In one embodiment, the expression of “the second information block being used to determine a first coding rate” in the claim comprises the following meaning: the second information block is used to explicitly or implicitly indicate the first coding rate.

In one embodiment, the expression of “the second information block being used to determine a first coding rate” in the claim comprises the following meaning: one or multiple fields comprised in the second information block is used to explictly or implicitly indicate the first coding rate.

In one embodiment, the first coding rate is a configured Maximum PUCCH coding rate.

In one embodiment, the first coding rate is a coding rate when the first bit block is rate matching.

In one embodiment, the first coding rate is an expected coding rate when the first bit block is rate matching.

In one embodiment, the first coding rate is a coding rate when the second bit block is rate matching.

In one embodiment, the first coding rate is an expected coding rate when the second bit block is rate matching.

In one embodiment, the first number value is a positive integer.

In one embodiment, the first number value is not greater than a number of PRB(s) comprised in the target PUCCH resource in the present application in frequency domain.

In one embodiment, a number of PRB(s) occupied by the first PUCCH in an OFDM symbol in frequency domain is equal to the first number value.

In one embodiment, a number of PRB(s) occupied by the first PUCCH in a Hop in frequency domain is equal to the first number value.

In one embodiment, the expression of “the first coding rate being used to determine the first number value” in the claim comprises the following meaning: the first coding rate is used by the first node in the present application to determine the first number value.

In one embodiment, the expression of “the first coding rate being used to determine the first number value” in the claim comprises the following meaning: the first coding rate is used to calculate the first number value.

In one embodiment, the expression of “the first coding rate being used to determine the first number value” in the claim comprises the following meaning: the first coding rate and a characteristic number value are used together to calculate the first number value, and at least one of a number of control information bit(s) comprised in the first bit block or a number of control information bit(s) comprised in the second bit block is used to determine the characteristic number value, the characteristic number value being a positive integer.

In one embodiment, the expression of “the first coding rate being used to determine the first number value” in the claim comprises the following meaning: the first coding rate and a characteristic number value are used together to calculate the first number value, and at least one of a number of control information bit(s) comprised in the first bit block or a number of control information bit(s) comprised in the second bit block is used to determine the characteristic number value, the characteristic number value being apositive integer; when a number of information bit(s) is equal to a characteristic number value, the first number value is equal to a minimum number of PRB(s) satisfying coding rate after rate matching not greater than the first coding rate.

In one embodiment, a number of bit(s) comprised in the first bit sequence is also proportional to a number of OFDM symbol(s) occupied by the first PUCCH.

In one embodiment, a number of bit(s) comprised in the first bit sequence is also proportional to a number of OFDM symbol(s) (excluding OFDM symbol(s) occupied by a reference signal) occupied by the first PUCCH.

In one embodiment, a number of bit(s) comprised in the first bit sequence is also proportional to a number of OFDM symbol(s) (comprising OFDM symbol(s) occupied by areference signal) occupied by the first PUCCH.

In one embodiment, a number of bit(s) comprised in the first bit sequence is also inversely proportional to a spreading factor adopted by the first PUCCH.

In one embodiment, a number of bit(s) comprised in the first bit sequence is equal to a result calculated by the following equation:

16·N_{symb,UCI}^{PUCCH,2}·N_{PRB}^{PUCCH,2}/N_{SF}^{PUCCH,2}

herein, N_{PRB}^{PUCCH,2} represents the first number value N_{symb,UCI}^{PUCCH,2} represents a number of OFDM symbol(s) occupied by the first PUCCH, and N_{SF}^{PUCCH,2} represents a spreading factor of the first PUCCH.

In one embodiment, a number of bit(s) comprised in the first bit sequence is equal to a result calculated by the following equation:

24·N_{symb,UCI}^{PUCCH,3}·N_{PRB}^{PUCCH,3}/N_{SF}^{PUCCH,3}

herein, N_{PRB}^{PUCCH,3} represents the first number value N_{symb,UCI}^{PUCCH,3} represents a number of OFDM symbol(s) (excluding OFDM symbol(s) occupied by a reference signal) occupied by the first PUCCH, and N_{SF}^{PUCCH,3} represents a spreading factor of the first PUCCH.

In one embodiment, a number of bit(s) comprised in the first bit sequence is equal to a result calculated by the following equation:

12·N_{symb,UCI}^{PUCCH,3}·N_{PRB}^{PUCCH,3}/N_{SF}^{PUCCH,3}

herein, N_{PRB}^{PUCCH,3} represents the first number value, N_{symb,UCI}^{PUCCH,3} represents a number of OFDM symbol(s) (excluding OFDM symbol(s) occupied by a reference signal) occupied by the first PUCCH, and N_{SF}^{PUCCH,3} represents a spreading factor of the first PUCCH.

In one embodiment, the first coding rate is equal to one of X2 candidate coding rates, X2 being a positive integer greater than 1; a specific coding rate is equal to a predefined candidate coding rate among the X2 candidate coding rates, the first coding rate being not equal to the specific coding rate is used to determine that the first bit block and the second bit block are used together to generate the first PUCCH.

In one embodiment, a type of a UCI carried by the first PUCCH is one of a first UCI type or a second UCI type, the first UCI type is a UCI comprising CSI, and the second UCI type is a UCI not comprising CSI.

In one embodiment, a type of a UCI carried by the first PUCCH is a first UCI type or a second UCI type, the first UCI type is a UCI comprising control information with different priorities, and the second UCI type is a UCI only comprising control information with a same priority.

In one embodiment, a type of a UCI carried by the first PUCCH is one of a first UCI type or a second UCI type, the first UCI type is a UCI comprising HARQ-ACKs with different priorities, and the second UCI type is a UCI only comprising HARQ-ACK with a same priority or only comprising HARQ-ACK and CSI with a same priority or only comprising CSI with a same priority.

In one embodiment, a type of a UCI carried by the first PUCCH is one of a first UCI type or a second UCI type, the first UCI type is a UCI comprising HARQ-ACKs with different priorities, and the second UCI type is a UCI type other than the first UCI type.

In one embodiment, the expression of “a type of a UCI carried by the first PUCCH being used to determine the first coding rate” in the claim comprises the following meaning: a type of a UCI carried by the first PUCCH is used by the first node in the present application to determine the first coding rate.

In one embodiment, the expression of “a type of a UCI carried by the first PUCCH being used to determine the first coding rate” in the claim comprises the following meaning: the first coding rate is equal to one of two candidate coding rates, the two candidate coding rates respectively correspond to a first UCI type and a second UCI type, and a type of a UCI carried by the first PUCCH is one of the first UCI type or the second UCI type; the first coding rate is equal to a candidate coding rate corresponding to a type of a UCI carried by the first PUCCH in the two candidate coding rates. In one subsidiary embodiment of the above embodiment, the first UCI type is a UCI comprising a CSI, and the second UCI type is a UCI not comprising a CSI. In one subsidiary embodiment of the above embodiment, the first UCI type is a UCI comprising control information with different priorities, and the second UCI type is a UCI only comprising control information with a same priority. In one subsidiary embodiment of the above embodiment, the first UCI type is a UCI comprising HARQ-ACKs with different priorities, and the second UCI type is a UCI only comprising HARQ-ACK with a same priority or only comprising HARQ-ACK and CSI with same priorities or only comprising CSI with a same priority. In one subsidiary embodiment of the above embodiment, the first UCI type is a UCI comprising HARQ-ACKs with different priorities, and the second UCI type is a UCI type other than the first UCI type. In one subsidiary embodiment of the above embodiment, the two candidate coding rates are configurable. In one subsidiary embodiment of the above embodiment, the two candidate coding rates are pre-defined. In one subsidiary embodiment of the above embodiment, both the two candidate coding rates are configured through the second information block.

### Embodiment 11

Embodiment 11 illustrates the structure diagram of a processor in a first node, as shown in FIG. 11. In FIG. 11, a processor 1100 in a first node comprises a first receiver 1101 and a first transmitter 1102. The first receiver 1101 comprises the transmitter/receiver 456 (including the antenna 460), the receiving processor 452 and the controller/processor 490 in FIG. 4 of the present application; the first transmitter 1102 comprises the transmitter/receiver 456 (including the antenna 460) and the transmitting processor 455 in FIG. 4 of the present application.

In embodiment 11, the first receiver 1101 receives a first information block, the first information block is used to determine a first parameter value, the first parameter value is used to generate a first scrambling sequence, the first parameter value is a non-negative integer, the first scrambling sequence comprises multiple sequentially indexed bits; the first transmitter 1102 transmits a first PUCCH, the first PUCCH is used to carry a first bit block and a second bit block, the first bit block comprises at least one control information bit, and the second bit block comprises at least one control information bit; herein, a number of control information bit(s) comprised in the first bit block is not greater than 2; a sum of a number of control information bit(s) comprised in the first bit block and a number of control information bit(s) comprised in the second bit block is greater than 2; a priority index of a control information bit comprised in the first bit block is equal to a first priority index, a priority index of a control information bit comprised in the second bit block is equal to a second priority index, and the first priority index is not equal to the second priority index; the first bit block and the second bit block are used together to generate a first bit sequence, and the first bit sequence comprises multiple sequentially indexed bits; the first bit sequence comprises at least one placeholder bit, a non-placeholder bit comprised in the first bit sequence is scrambled by a bit with a same index in the first scrambling sequence.

In one embodiment, a modulation order of a modulation scheme adopted by the first PUCCH is equal to a first modulation order, and the first modulation order is a positive integer greater than 1; a number of control information bit(s) comprised in the first bit block being less than the first modulation order is used to determine that the first bit sequence comprises at least one placeholder bit.

In one embodiment, the first bit sequence and the first scrambling sequence are used together to generate a first output sequence, the first output sequence comprises multiple sequentially indexed bits, and a number of bits comprised in the first output sequence is equal to a number of bits comprised in the first bit sequence; a first index is an index of a placeholder bit comprised in the first bit sequence, a bit with index equal to the first index comprised in the first output sequence is a first bit, a second bit is a bit comprised in the first output sequence, the second index is an index of the second bit in the first output sequence, the second index and the first index are two adjacent indexes, and a bit value of the first bit is equal to a bit value of the second bit.

In one embodiment, the first receiver 1101 receives a second information block; herein, the second information block is used to determine X1 resource sets, X1 being a positive integer greater than 1; any of the X1 resource sets comprises at least one PUCCH resource, resources occupied by the first PUCCH belong to a target PUCCH resource, and the target PUCCH resource is a PUCCH resource comprised in a target resource set; the target resource set is one of the X1 resource sets, and a target number value is used to determine the target resource set out of the X1 resource sets, the target number value being a positive integer; at least one of a number of control information bit(s) comprised in the first bit block, or a number of control information bit(s) comprised in the second bit block is used to determine the target number value.

In one embodiment, the first receiver 1101 receives a first signaling; herein, when the target resource set comprises more than one PUCCH resource, the first signaling is used to determine the target PUCCH resource from the target resource set.

In one embodiment, whether a number of control information bit(s) comprised in the second bit block is used to determine that the target number value is related to the second priority index.

In one embodiment, the second information block is used to determine a first coding rate, and the first coding rate is a non-negative number; a number of PRB(s) occupied by the first PUCCH in frequency domain is equal to a first number value; the first coding rate is used to determine the first number value, and a number of bit(s) comprised in the first bit sequence is directly proportional to the first number value; a type of a UCI carried by the first PUCCH is used to determine the first coding rate.

### Embodiment 12

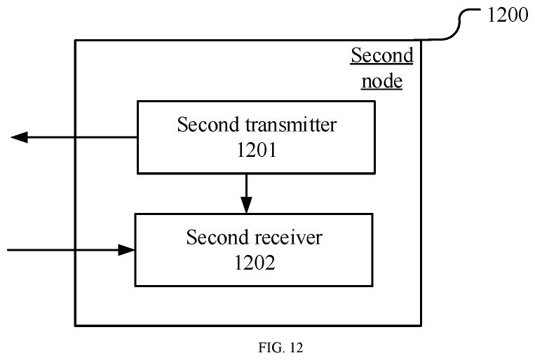

Embodiment 12 illustrates the structure diagram of a processor in a second node, as shown in FIG. 12. In FIG. 12, a processor 1200 in a second node comprises a second transmitter 1201 and a second receiver 1202. The second transmitter 1201 comprises the transmitter/receiver 416 (including the antenna 460), the transmitting processor 415 and the controller/processor 440 in FIG. 4 of the present application; the second receiver 1202 comprises the transmitter/receiver 416 (including the antenna 460) and the receiving processor 412 in FIG. 4 in the present application.

In embodiment 12, the second transmitter 1201 transmits a first information block, the first information is used to indicate a first parameter value, the first parameter value is used to generate a first scrambling sequence, the first parameter value is a non-negative integer, the first scrambling sequence comprises multiple sequentially indexed bits; the second receiver 1202 receives a first PUCCH, the first PUCCH is used to carry a first bit block and a second bit block, the first bit block comprises at least one control information bit, and the second bit block comprises at least one control information bit; herein, a number of control information bit(s) comprised in the first bit block is not greater than 2; a sum of a number of control information bit(s) comprised in the first bit block and a number of control information bit(s) comprised in the second bit block is greater than 2; a priority index of a control information bit comprised in the first bit block is equal to a first priority index, a priority index of a control information bit comprised in the second bit block is equal to a second priority index, and the first priority index is not equal to the second priority index; the first bit block and the second bit block are used together to generate a first bit sequence, and the first bit sequence comprises multiple sequentially indexed bits; the first bit sequence comprises at least one placeholder bit, a non-placeholder bit comprised in the first bit sequence is scrambled by a bit with a same index in the first scrambling sequence. the second receiver 1202 receives a first PUCCH.

In one embodiment, a modulation order of a modulation scheme adopted by the first PUCCH is equal to a first modulation order, and the first modulation order is a positive integer greater than 1; a number of control information bit(s) comprised in the first bit block being less than the first modulation order is used to determine that the first bit sequence comprises at least one placeholder bit.

In one embodiment, the first bit sequence and the first scrambling sequence are used together to generate a first output sequence, the first output sequence comprises multiple sequentially indexed bits, and a number of bits comprised in the first output sequence is equal to a number of bits comprised in the first bit sequence; a first index is an index of a placeholder bit comprised in the first bit sequence, a bit with index equal to the first index comprised in the first output sequence is a first bit, a second bit is a bit comprised in the first output sequence, the second index is an index of the second bit in the first output sequence, the second index and the first index are two adjacent indexes, and a bit value of the first bit is equal to a bit value of the second bit.

In one embodiment, the second transmitter 1201 transmits a second information block; herein, the second information block is used to determine X1 resource sets, X1 being a positive integer greater than 1; any of the X1 resource sets comprises at least one PUCCH resource, resources occupied by the first PUCCH belong to a target PUCCH resource, and the target PUCCH resource is a PUCCH resource comprised in a target resource set; the target resource set is one of the X1 resource sets, and a target number value is used to determine the target resource set out of the X1 resource sets, the target number value being a positive integer; at least one of a number of control information bit(s) comprised in the first bit block, or a number of control information bit(s) comprised in the second bit block is used to determine the target number value.

In one embodiment, the second transmitter 1201 transmits a first signaling; herein, when the target resource set comprises more than one PUCCH resource, the first signaling is used to determine the target PUCCH resource from the target resource set.

In one embodiment, whether a number of control information bit(s) comprised in the second bit block is used to determine that the target number value is related to the second priority index.

In one embodiment, the second information block is used to determine a first coding rate, and the first coding rate is a non-negative number; a number of PRB(s) occupied by the first PUCCH in frequency domain is equal to a first number value; the first coding rate is used to determine the first number value, and a number of bit(s) comprised in the first bit sequence is directly proportional to the first number value; a type of a UCI carried by the first PUCCH is used to determine the first coding rate.

The ordinary skill in the art may understand that all or part of steps in the above method may be implemented by instructing related hardware through a program. The program may be stored in a computer readable storage medium, for example Read-Only Memory (ROM), hard disk or compact disc, etc. Optionally, all or part of steps in the above embodiments also may be implemented by one or more integrated circuits. Correspondingly, each module unit in the above embodiment may be realized in the form of hardware, or in the form of software function modules. The first node or the second node in the present application includes but is not limited to mobile phones, tablet computers, notebooks, network cards, low-consumption equipment, enhanced MTC (eMTC) terminals, NB-IOT terminals, vehicle-mounted communication equipment, aircrafts, diminutive airplanes, unmanned aerial vehicles, telecontrolled aircrafts, test device, test equipment, test instrument and other wireless communication devices. The base station or network side equipment in the present application includes but is not limited to macro-cellular base stations, micro-cellular base stations, home base stations, relay base station, eNB, gNB, Transmitter Receiver Point (TRP), relay satellites, satellite base stations, space base stations, test device, test equipment, test instrument and other radio communication equipment.

The above are merely the preferred embodiments of the present application and are not intended to limit the scope of protection of the present application. Any modification, equivalent substitute and improvement made within the spirit and principle of the present application are intended to be included within the scope of protection of the present application.

What is claimed is:

1. A first node for wireless communications, comprising:
a first receiver, receiving a first information block, the first information block being used to determine a first parameter value, the first parameter value being used to generate a first scrambling sequence, the first parameter value being a non-negative integer, the first scrambling sequence comprising multiple sequentially indexed bits; and
a first transmitter, transmitting a first Physical Uplink Control Channel (PUCCH), the first PUCCH being used to carry a first bit block and a second bit block, the first bit block comprising at least one control information bit, and the second bit block comprising at least one control information bit;
wherein a number of control information bit(s) comprised in the first bit block is not greater than 2; a sum of a number of control information bit(s) comprised in the first bit block and a number of control information bit(s) comprised in the second bit block is greater than 2; a priority index of a control information bit comprised in the first bit block is equal to a first priority index, a priority index of a control information bit comprised in the second bit block is equal to a second priority index, and the first priority index is not equal to the second priority index; the first bit block and the second bit block are used together to generate a first bit sequence, and the first bit sequence comprises multiple sequentially indexed bits; the first bit sequence comprises at least one placeholder bit, a non-placeholder bit comprised in the first bit sequence is scrambled by a bit with a same index in the first scrambling sequence.

2. The first node according to claim 1, wherein a modulation order of a modulation scheme adopted by the first PUCCH is equal to a first modulation order, and the first modulation order is a positive integer greater than 1; a number of control information bit(s) comprised in the first bit block being less than the first modulation order is used to determine that the first bit sequence comprises at least one placeholder bit.

3. The first node according to claim 1, wherein the first bit sequence and the first scrambling sequence are used together to generate a first output sequence, the first output sequence comprises multiple sequentially indexed bits, and a number of bits comprised in the first output sequence is equal to a number of bits comprised in the first bit sequence; a first index is an index of a placeholder bit comprised in the first bit sequence, a bit with index equal to the first index comprised in the first output sequence is a first bit, a second bit is a bit comprised in the first output sequence, the second index is an index of the second bit in the first output sequence, the second index and the first index are two adjacent indexes, and a bit value of the first bit is equal to a bit value of the second bit.

4. The first node according to claim 1, wherein the first receiver receives a second information block; wherein the second information block is used to determine X1 resource sets, X1 being a positive integer greater than 1; any of the X1 resource sets comprises at least one PUCCH resource, resources occupied by the first PUCCH belong to a target PUCCH resource, and the target PUCCH resource is a PUCCH resource comprised in a target resource set; the target resource set is one of the X1 resource sets, and a target number value is used to determine the target resource set out of the X1 resource sets, the target number value being a positive integer; at least one of a number of control information bit(s) comprised in the first bit block, or a number of control information bit(s) comprised in the second bit block is used to determine the target number value.

5. The first node according to claim 4, wherein the first receiver receives first signaling; wherein when the target resource set comprises more than one PUCCH resource, the first signaling is used to determine the target PUCCH resource from the target resource set.

6. The first node according to claim 4, wherein the target number value is equal to a sum of a number of control information bit(s) comprised in the first bit block and a number of control information bit(s) comprised in the second bit block; the X1 resource sets respectively correspond to X1 value ranges, the target number value belongs to a target value range, the target value range is one of the X1 value ranges, and the target resource set is a resource set corresponding to the target value range among the X1 resource sets; the X1 value ranges are configurable or the X1 value ranges are pre-defined.

7. The first node according to claim 4, wherein the second information block is used to determine a first coding rate, and the first coding rate is a non-negative number; a number of Physical Resource Block(s) (PRB(s)) occupied by the first PUCCH in frequency domain is equal to a first number value; the first coding rate is used to determine the first number value, and a number of bit(s) comprised in the first bit sequence is directly proportional to the first number value; a type of a Uplink Control Information (UCI) carried by the first PUCCH is used to determine the first coding rate.

8. A second node for wireless communications, comprising:
a second transmitter, transmitting a first information block, the first information block being used to indicate a first parameter value, the first parameter value being used to generate a first scrambling sequence, the first parameter value being a non-negative integer, the first scrambling sequence comprising multiple sequentially indexed bits; and
a second receiver, receiving a first PUCCH, the first PUCCH being used to carry a first bit block and a second bit block, the first bit block comprising at least one control information bit, and the second bit block comprising at least one control information bit;
wherein a number of control information bit(s) comprised in the first bit block is not greater than 2; a sum of a number of control information bit(s) comprised in the first bit block and a number of control information bit(s) comprised in the second bit block is greater than 2; a priority index of a control information bit comprised in the first bit block is equal to a first priority index, a priority index of a control information bit comprised in the second bit block is equal to a second priority index, and the first priority index is not equal to the second priority index; the first bit block and the second bit block are used together to generate a first bit sequence, and the first bit sequence comprises multiple sequentially indexed bits; the first bit sequence comprises at least one placeholder bit, a non-placeholder bit comprised in the first bit sequence is scrambled by a bit with a same index in the first scrambling sequence.

9. The second node according to claim 8, wherein a modulation order of a modulation scheme adopted by the first PUCCH is equal to a first modulation order, and the first modulation order is a positive integer greater than 1; a number of control information bit(s) comprised in the first bit block being less than the first modulation order is used to determine that the first bit sequence comprises at least one placeholder bit.

10. The second node according to claim 8, wherein the first bit sequence and the first scrambling sequence are used together to generate a first output sequence, the first output sequence comprises multiple sequentially indexed bits, and a number of bits comprised in the first output sequence is equal to a number of bits comprised in the first bit sequence; a first index is an index of a placeholder bit comprised in the first bit sequence, a bit with index equal to the first index comprised in the first output sequence is a first bit, a second bit is a bit comprised in the first output sequence, the second index is an index of the second bit in the first output sequence, the second index and the first index are two adjacent indexes, and a bit value of the first bit is equal to a bit value of the second bit.

11. The second node according to claim 8, wherein the second transmitter transmits a second information block; wherein the second information block is used to determine X1 resource sets, X1 being a positive integer greater than 1; any of the X1 resource sets comprises at least one PUCCH resource, resources occupied by the first PUCCH belong to a target PUCCH resource, and the target PUCCH resource is a PUCCH resource comprised in a target resource set; the target resource set is one of the X1 resource sets, and a target number value is used to determine the target resource set out of the X1 resource sets, the target number value being a positive integer; at least one of a number of control information bit(s) comprised in the first bit block, or a number of control information bit(s) comprised in the second bit block is used to determine the target number value.

12. The first node according to claim 11, wherein the second transmitter transmits a first signaling; wherein when the target resource set comprises more than one PUCCH resource, the first signaling is used to determine the target PUCCH resource from the target resource set.

13. The second node according to claim 11, wherein the second information block is used to determine a first coding rate, and the first coding rate is a non-negative number; a number of PRB(s) occupied by the first PUCCH in frequency domain is equal to a first number value; the first coding rate is used to determine the first number value, and a number of bit(s) comprised in the first bit sequence is directly proportional to the first number value; a type of a UCI carried by the first PUCCH is used to determine the first coding rate.

14. A method in a first node for wireless communications, comprising:
receiving a first information block, the first information block being used to determine a first parameter value, the first parameter value being used to generate a first scrambling sequence, the first parameter value being a non-negative integer, the first scrambling sequence comprising multiple sequentially indexed bits; and
transmitting a first PUCCH, the first PUCCH being used to carry a first bit block and a second bit block, the first bit block comprising at least one control information bit, and the second bit block comprising at least one control information bit;
wherein a number of control information bit(s) comprised in the first bit block is not greater than 2; a sum of a number of control information bit(s) comprised in the first bit block and a number of control information bit(s) comprised in the second bit block is greater than 2; a priority index of a control information bit comprised in the first bit block is equal to a first priority index, a priority index of a control information bit comprised in the second bit block is equal to a second priority index, and the first priority index is not equal to the second priority index; the first bit block and the second bit block are used together to generate a first bit sequence, and the first bit sequence comprises multiple sequentially indexed bits; the first bit sequence comprises at least one placeholder bit, a non-placeholder bit comprised in the first bit sequence is scrambled by a bit with a same index in the first scrambling sequence.

15. The method in a first node according to claim 14, wherein a modulation order of a modulation scheme adopted by the first PUCCH is equal to a first modulation order, and the first modulation order is a positive integer greater than 1; a number of control information bit(s) comprised in the first bit block being less than the first modulation order is used to determine that the first bit sequence comprises at least one placeholder bit.

16. The method in a first node according to claim 14, wherein the first bit sequence and the first scrambling sequence are used together to generate a first output sequence, the first output sequence comprises multiple sequentially indexed bits, and a number of bits comprised in the first output sequence is equal to a number of bits comprised in the first bit sequence; a first index is an index of a placeholder bit comprised in the first bit sequence, a bit with index equal to the first index comprised in the first output sequence is a first bit, a second bit is a bit comprised in the first output sequence, the second index is an index of the second bit in the first output sequence, the second index and the first index are two adjacent indexes, and a bit value of the first bit is equal to a bit value of the second bit.

17. The method in a first node according to claim 14, comprising:
receiving a second information block;
wherein the second information block is used to determine X1 resource sets, X1 being a positive integer greater than 1; any of the X1 resource sets comprises at least one PUCCH resource, resources occupied by the first PUCCH belong to a target PUCCH resource, and the target PUCCH resource is a PUCCH resource comprised in a target resource set; the target resource set is one of the X1 resource sets, and a target number value is used to determine the target resource set out of the X1 resource sets, the target number value being a positive integer; at least one of a number of control information bit(s) comprised in the first bit block, or a number of control information bit(s) comprised in the second bit block is used to determine the target number value.

18. The method in a first node according to claim 17, comprising:
receiving a first signaling;
wherein when the target resource set comprises more than one PUCCH resource, the first signaling is used to determine the target PUCCH resource from the target resource set.

19. The method in a first node according to claim 17, wherein the target number value is equal to a sum of a number of control information bit(s) comprised in the first bit block and a number of control information bit(s) comprised in the second bit block; the X1 resource sets respectively correspond to X1 value ranges, the target number value belongs to a target value range, the target value range is one of the X1 value ranges, and the target resource set is a resource set corresponding to the target value range among the X1 resource sets; the X1 value ranges are configurable or the X1 value ranges are pre-defined.

20. The method in a first node according to claim 17, wherein the second information block is used to determine a first coding rate, and the first coding rate is a non-negative number; a number of PRB(s) occupied by the first PUCCH in frequency domain is equal to a first number value; the first coding rate is used to determine the first number value, and a number of bit(s) comprised in the first bit sequence is directly proportional to the first number value; a type of a UCI carried by the first PUCCH is used to determine the first coding rate.
